(19) United States
(12) Patent Application Publication
(10) Pub. No.: US 2009/0138203 A1
(43) Pub. Date: May 28, 2009

(54) SYSTEMS AND METHODS FOR USING MOLECULAR NETWORKS IN GENETIC LINKAGE ANALYSIS OF COMPLEX TRAITS

(76) Inventors: Ivan Iossifov, Philadelphia, PA (US); Tian Zheng, New York, NY (US); Andrey Rzhetsky, New York, NY (US)

Correspondence Address: BAKER BOTTS L.L.P., 30 ROCKEFELLER PLAZA, 44TH FLOOR, NEW YORK, NY, 10112-4498, US

(21) Appl. No.: 12/207,024

(22) Filed: Sep. 9, 2008

Related U.S. Application Data
(63) Continuation of application No. PCT/US07/65501, filed on Mar. 29, 2007.
(60) Provisional application No. 60/787,712, filed on Mar. 29, 2006.
(60) Provisional application No. 60/787,711, filed on Mar. 29, 2006.
(60) Provisional application No. 60/788,794, filed on Apr. 3, 2006.

(51) Int. Cl. G06F 17/18; G06F 19/00

(52) U.S. Cl. 702/19; 702/181

(57) ABSTRACT

The present disclosed subject matter relates to methods of using molecular networks in whole genome genetic linkage analysis of complex inherited disorders, including determining gene-specific linkage probability values for one or more genes represented in a predetermined molecular interaction network. The present disclosed subject matter further relates to methods of identifying one or more gene that is associated with one or more heritable diseases, and methods of diagnosing the heritable diseases.

### CROSS REFERENCE TO RELATED APPLICATIONS

This application is a continuation of International Application PCT/US07/65501 filed Mar. 29, 2007 which claims the benefit of priority to U.S. Provisional applications No. 60/787,712 filed Mar. 29, 2006; 60/787,711 filed Mar. 29, 2006; and 60/788,794 filed Apr. 3, 2006, the contents of each of which are incorporated herein in their entireties.

### STATEMENT REGARDING FEDERALLY SPONSORED RESEARCH

This invention was made with government support under grant number GM61372 awarded by the National Institutes of Health and Contract FA8750-04-2-0123 awarded by the United States Air Force. The government has certain rights in the invention.

### BACKGROUND

The disclosed subject matter relates to techniques for using molecular networks in whole genome genetic linkage analysis of complex inherited disorders, including determining gene-specific linkage probability values for genes represented in a molecular interaction network.

Recent advancements in our understanding of the human genome offer promise that the genetic bases for diseases will eventually be understood. To date, however, there are only a few inherited diseases that are known to be caused by mutations in specific genes, such as sickle cell anemia, Duchenne muscular dystrophy, and Huntington's chorea. Other diseases, which clearly manifest a genetic basis, such as obesity, diabetes, cancer, and Alzheimers disease, have not been clearly linked to any one genetic variation. Three disorders falling within this category, schizophrenia, bipolar disorder, and autism, appear to have an inheritance pattern which is particularly complex.

Bipolar disorder, schizophrenia and autism are highly prevalent polygenic disorders that have high heritability and thus should be linked to genetic variations within the human genome. However, identifying specific polymorphisms that predispose their bearer to these complex disorders has proven to be very difficult.

Autism [MIM209850] is a neuropsychiatric developmental disorder with a prevalence of 4-10 per 10,000, and a nearly fourfold higher incidence in boys than in girls. Diagnostic features of autism include severely impaired development of social interactions, marked and sustained impairment of verbal and nonverbal communication, and restricted or repetitive behaviors and interests with an onset within the first three years of life. What is referred to vernacularly as “autism” is, in fact, a broad spectrum of disorders, including classical autism, the most severe manifestation of the disorder spectrum, and Asperger syndrome (AS [MIM209850]). Formally, these disorders are referred to collectively as “pervasive developmental disorders” (PDDs [MIM209850]). Autism and autism spectrum disorders (ASD), which have a higher prevalence of 10-60 individuals per 10,000, share essential clinical and behavior manifestations although they differ in severity and age of onset.

Bipolar disorder (BPD; loci MAFD1 [MIM 125480] and MAFD2 [MIM 309200]) is a complex psychiatric disorder with a worldwide lifetime prevalence of 0.5%-11.5% and a predominantly genetic etiology. BPD is characterized by episodes of mania, with elated or irritable-angry mood and symptoms like pressured speech, racing thoughts, grandiose ideas, increased energy, and reckless behavior, alternating with more normal periods and, in most cases, with episodes of depression. Studies investigating linkage in BPD have identified regions on chromosome 11, the X chromosome, and chromosome 18, but no gene has been identified as having a definitive role in the development of the disorder.

Schizophrenia (MIM 181500) is a complex neurological disorder affecting 0.5%-1% of the general population. Manifestations of schizophrenia include delusions, disordered thought, hallucinations, blunted emotions, paranoid ideation, and motor abnormalities such as stereotypic behaviors and catatonia as well as impaired memory, attention, and executive function.

Like all of the polygenic disorders discussed herein, the cause of schizophrenia is unknown, but certain family and adoption studies suggest that schizophrenia has a significant genetic component. Numerous genomewide linkage scans have been reported for schizophrenia, with some evidence for linkage with several loci, including chromosome regions 6p24-p22, 1q21-q22, 13q32-q34, 10p14, and 10q25.3-q26.3. Linkage with other regions, including 8p22-p21, 6p21-q25 (MIM 603175), 22q12-q13, and 5q21 have also been reported.

Despite their differences, schizophrenia, bipolar disorder and autism share important symptoms. Autism, which was recognized as an independent disorder relatively recently, was originally called “childhood schizophrenia.” Similarly, bipolar disorder and schizophrenia are two poles connected by a continuum of phenotypes, with schizoaffective disorder, manifesting symptoms of both bipolar disorder and schizophrenia, in the middle. The similarity of several symptoms exhibited in schizophrenia and bipolar disorder have led some to believe that they share a genetic basis.

Traditionally, human genetic linkage analysis has been carried out as a pairwise comparison between a trait locus and each of a number of marker loci. For each comparison, trait versus the i^{th} marker, or marker versus marker, are computed and combined over families. With the development of dense linkage maps, simultaneous analysis of several linked loci—multipoint linkage analysis—is now standard practice. Multipoint linkage analysis, however, has several limitations. For one, it is still conducted one chromosome at a time. Moreover, even when a trait is governed by multiple disease genes, analysis is usually carried out under the assumption that a single gene is responsible for a single disorder.

In particular with polygenic disorders, a major technical obstacle in multipoint linkage analysis is that the exponentially expanding search space of combinations of genetic loci must be considered. If one assumes that m distinct loci predispose or contribute to a given polygenic disorder, a separate statistical hypothesis test for each distinct combination of m genetic loci must be run. As a result, the number of statistical tests of significance performed on the same data set typically becomes too large to allow for any useful level of statistical power.

Accordingly, there exists a need in the art to improve the amount of biological information gathered from a genetic linkage association, so as to better predict, diagnose and treat a genetic disorder.

### SUMMARY

The disclosed subject matter provides techniques for identifying disease-associated genes combining the mathematics of genetic linkage analysis with the mathematics of molecular network analysis. The disclosed subject matter allows one to perform linkage analysis on a genomewide basis, rather than a single chromosome, and not be overburdened by the associated number of statistical tests. Moreover, the disclosed subject matter draws on the body of information gathered for a particular gene to place the genetic findings in context and to identify genes or groups of genes that are in a close molecular network that underlie or predispose an individual to a complex genetic disorder.

In some embodiments, the disclosed subject matter provides for a method of identifying two or more genes associated with a disease, where each of the genes is a member of a predetermined molecular network. For each of the genes, the method involves determining (a) a gene-specific probability value that the gene is associated with the disease and (b) a theoretical probability value that the gene is not associated with the disease. The probability value from (a) can be compared with the probability value of (b) for each gene to determine whether the genes are associated with the disease.

In some embodiments, once a gene within a predetermined molecular network has been selected, to test whether that gene is associated with a disease, the chromosomal locus in which that gene resides can be evaluated in members of an afflicted pedigree, using already available genetic data. The genetic features of that locus in a member subject afflicted with the disease can be compared to those of a healthy member to determine whether they are the same or different, the result of which can be expressed as a probability value. To accomplish this, a probability value reflecting either the likelihood that a gene is or is not associated with the disease being analyzed can be ascertained by determining a logarithm of the odds (“LOD”) score for a given gene relative to a corresponding chromosomal locus in a subject member of a pedigree under analysis, to assign a probability to whether a variation in the gene exists and whether the variation is associated with the disease, or normal, phenotype in the subject.

In some embodiments of the disclosed subject matter, this method can further include applying a bootstrap loop computation to the LOD scores. The bootstrap loop involves generating bootstrap replicate data sets of pedigrees represented in a predetermined data set. The method can further include identifying a gene cluster with a maximum cluster LOD score among a plurality of gene clusters containing genes that have been scored.

In some embodiments of the disclosed subject matter, it can be assumed that there is exactly one disease predisposing genetic locus per pedigree (also referred to herein as a family). Thus, a LOD score can be computed for an individual position (λ) in the genome using Equation 1; a gene cluster LOD score can be defined using Equation 2 and a cluster LOD score can be calculated using Equation 3:

$$\begin{matrix} L O {D}_{f} ( λ ) = {log}_{10} \frac{P ( {Y}_{f} \vert D - predisposing position is at λ , Θ )}{P ( \begin{matrix}{Y}_{f} \vert D - \\ predisposing position is unlinked , Θ\end{matrix} )} . & ( 1 ) \\ L O D ( C = \{ {gene}_{1} , … , {gene}_{c} \} , Θ ) = {log}_{10} \frac{P ( Y \vert C = \{ {gene}_{1} , … , {gene}_{c} \} , Θ )}{P ( Y \vert C = \{ \} , Θ )} , & ( 2 ) \\ L O D ( C = \{ {gene}_{1} , … , {gene}_{c} \} , Θ ) = {\sum }_{f} {log}_{10} {\sum }_{i = 1}^{c} {p}_{i} \frac{P ( {Y}_{f} \vert {gene}_{i} predisposes to D )}{P ( {Y}_{f} \vert D - predisposing position is unlinked , Θ )} = {\sum }_{f} {log}_{10} {\sum }_{i = 1}^{c} {p}_{i} {10}^{{LOD}_{f ( {gene}_{1} )}} . & ( 3 )\end{matrix}$$

Where there is a single gene cluster (c=1 and p1=1), the LOD score of Equation 3 is the sum of the gene-wise LOD scores for all individual families.

In still further embodiments, the disclosed subject matter provides for the determination of an overlap probability value that two or more genes correlate with more than one disease. The overlap probability value is the product of a probability value for a given gene being associated with a first disease and a probability value for the given gene being associated with a second disease.

In some embodiments, the disclosed subject matter provides for a method for identifying two or more genes associated with a disorder including (1) defining a network of one or more related genes, (2) selecting a test gene from the network, and (3) in a data set containing marker loci for an afflicted pedigree, determining the probability that one or more marker in or near the chromosomal locus containing the test gene varies between members afflicted with the disorder and members not afflicted with the disorder. A LOD score for either association or lack of association with the disease can be determined.

If there is at least one other gene in the network that has not been a test gene, (1)-(3) can be repeated for the other gene. Once the desired numbers of genes in the network have been tested relative to a given afflicted pedigree, the process can be repeated for a second afflicted pedigree. The aggregate probability that one or more gene in a cluster within the network is associated with the disease can be determined, e.g., by determining the gene cluster LOD.

Where the probability of correlating any one gene in the cluster can be very low (so low as to escape statistical significance), the analysis can be expanded to multiple genes in the cluster to make it more likely to identify a statistical correlation between functionally related genes and a disorder. Use of the cluster thus amplifies the correlation.

In some embodiments of the disclosed subject matter, a “molecular network” can be a network of physically interacting molecules. In other embodiments, a molecular network can be any assemblage of gene products believed to have a direct or indirect structural or functional relationship.

### BRIEF DESCRIPTION OF THE DRAWINGS

A more complete understanding of this disclosure can be acquired by referring to the following description taken in combination with the accompanying figures in which:

FIG. 1 is a functional diagram of an embodiment of a method for identifying one or more genes that contribute to an inherited disorder in accordance with the disclosed subject matter.

FIG. 2 is a functional diagram of the relationship between original data and a molecular network.

FIG. 3 is a functional diagram of a method of the disclosed subject matter to determine a real gene probability value that one or more gene contributes to a polygenic disorder.

FIG. 4 is a functional diagram of a method of the disclosed subject matter to determine a theoretical probability value that, for each of one or more gene, none contributes to a polygenic disorder.

FIG. 5 is a functional diagram of a method of the disclosed subject matter of a “Boot strap Loop.”

FIGS. 6A-B are functional diagrams of a method of the disclosed subject matter for identifying two or more genes, each of which contributes to two or more polygenic disorders.

FIG. 7 is a block diagram of a system for use in implementing the methods of the disclosed subject matter.

FIGS. 8A-C are schematic representations of the analysis of 14 top-scoring 10-gene clusters for autism data. FIG. 8A shows each cluster separately, where the vertex size represents the cluster probability estimated for the corresponding gene. The color of the cluster was used to encode cluster LOD scores. FIG. 8B shows the position of all genes represented in the 14 clusters on human autosomes. FIG. 8C shows the molecular network combining the 14 clusters in one graph. In this depiction, the colors and sizes of nodes indicate gene-specific p-values associated with each gene.

FIGS. 9A-C are schematic representations of the analysis of 14 top-scoring 10-gene clusters for the bipolar disorder data. FIG. 9A shows each cluster separately, where the vertex size represents the cluster probability estimated for the corresponding gene. The color of the cluster was used to encode cluster LOD scores. FIG. 9B shows the position of all genes represented in the 14 clusters on human autosomes. FIG. 9C shows the molecular network combining the 14 clusters in one graph. In this depiction, the colors and sizes of nodes indicate gene-specific p-values associated with each gene.

FIGS. 10A-C are schematic representations of the analysis of 14 top-scoring 10-gene clusters for the schizophrenia data. FIG. 10A shows each cluster separately, where the vertex size represents the cluster probability estimated for the corresponding gene. The color of the cluster was used to encode cluster LOD scores. FIG. 10B shows the position of all genes represented in the 14 clusters on human autosomes. FIG. 10C shows the molecular network combining the 14 clusters in one graph. In this depiction, the colors and sizes of nodes indicate gene-specific p-values associated with each gene.

FIGS. 11A-C are schematic representations of the molecular networks combining the 100 best 10-gene clusters for autism (FIG. 11A) and bipolar disorder (FIG. 11B) and the 50 best 10-gene clusters for schizophrenia (FIG. 11C). The color and sizes of nodes in all three networks indicate gene-specific p-values.

### DETAILED DESCRIPTION

The disclosed subject matter relates to methods of using molecular networks in whole genome genetic linkage analysis of complex inherited disorders, including determining gene-specific linkage probability values for one or more genes represented in a predetermined molecular interaction network. The disclosed subject matter simplifies the search for genetic loci that contribute to a complex or polygenic disorder by determining candidate genes to be tested as members of a molecular interaction network, so that the number of required significance tests can be reduced dramatically. As a result, the techniques disclosed herein, applied to analyze the inheritance of a disease of interest, can be used to identify a small number of high-significance candidate causative genes (a “gene cluster”). As an example of this approach, three disjoint data sets associated with different polygenic disorders (autism, bipolar disorder, and schizophrenia) were analyzed, and a nonrandom overlap among predicted candidate genes for all pairs, and for the triplet, of these disorders, was identified.

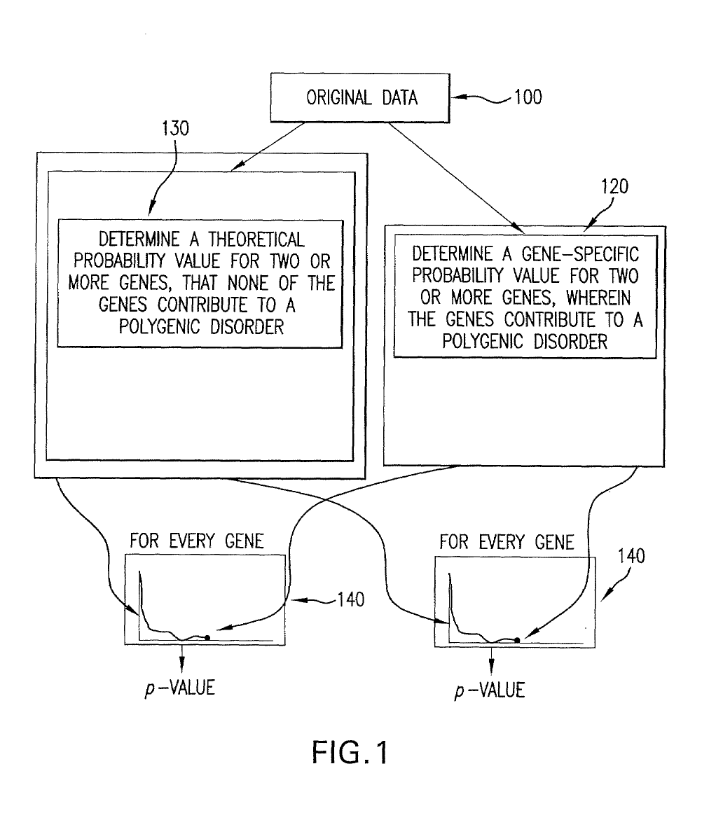

Referring now to FIG. 1, an exemplary method for identifying one or more genes that contribute to a putatively inherited disease will be described. The genes are selected from a predetermined gene cluster and evaluated against a predetermined data set 100 including data for afflicted and unafflicted individuals for a disease (in FIG. 1, a polygenic disorder). The method includes identifying a gene-specific probability value 120 that a gene is associated with the disease, determining a theoretical probability value 130 that the gene is not associated with the disease, and comparing 140 the gene-specific probability value 120 with the theoretical probability value 130 to determine whether or not the gene is associated with the disease.

As used herein, the term “disease” refers to conditions often collectively referred to as diseases and disorders (which preferably have been observed to have a heritable component, e.g. an occurrence rate which differs between families of afflicted individuals and the general population, and which includes, but is not limited to, polygenic disorders), and a gene “associated” with a disease is a gene that is expressed differently in an individual suffering from the disease relative to the normal population, either by the amount of expression (increased or decreased) or the structure of the gene or its product (e.g. a mutation, splice variant, etc.), where the associated gene can contribute to the etiology of the disease.

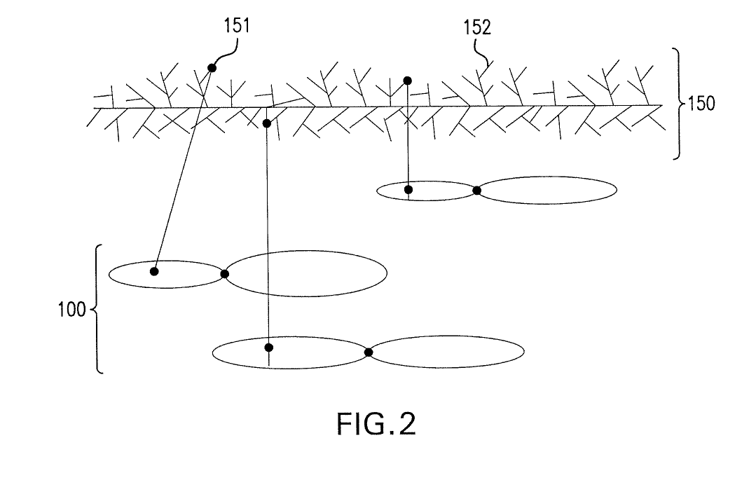

Referring now to FIG. 2, there is shown the relationship between the predetermined data set 100 and a predetermined molecular network 150. The predetermined data set 100 can include pedigrees of families with affected and nonaffected individuals. Each pedigree may provide a kinship structure and phenotypic information, disease phenotypes, genetic marker maps, e.g., the Généthon linkage map, and marker genotypes. All markers and genes can be arranged according to a sex-averaged genetic map. The position and molecular, genetic or biochemical data of each gene analyzed in the data set 100 is placed upon the framework of a predetermined molecular network 150.

The molecular network 150 provides biological information about functional relationships between genes. In some embodiments of the disclosed subject matter, the molecular network 150 used in the disclosed subject matter is a human-specific subset of the GeneWays 6.0 database (described in U.S. Pat. Nos. 6,950,753 and 6,633,819, the contents of which are incorporated by reference herein). GeneWays was used to mine nearly 250,000 full-text articles from 78 leaning biomedical journals. The network was created by removing all non-human-specific interactions; of the remaining interactions, only those interactions that are direct physical interactions are used. In addition, only those interactions for which all names of the involved genes or proteins are unambiguously mapped to a human GeneID defined by the National Cancer of Biotechnological Information (NCBI), and the gene's position on the chromosomes is known, were used. To integrate genes onto the molecular network, the NCBI Entrez Gene and the University of California Santa Cruz (UCSC) Genome Browser were used, along with the GeneIDs gene symbols, and the gene synonyms from the NCBI gene database, and the physical coordinates from the UCSC database.

The molecular network 150 used in the disclosed subject matter can include nodes 151 and edges 152. As used herein, “nodes” refer to a particular gene or gene family that defines a nucleus of biological function or activity. As used herein, “edges” refers to the functional interaction between the nodes. The interactions between the nodes can be, for example, physical, chemical or biochemical interactions. As used herein, “node degree” refers to the number of nodes (genes) that a particular node (gene) connects with.

The size and the quality of the molecular network 150 used in the methods according to the disclosed subject matter can have a significant impact on the quality of the statistical results. Generally, the larger the molecular network, the finer resolution of the analysis will be, and the number of highly significant candidate genes will increase.

Once a molecular network 150 is established with nodes (genes) 151, one can imagine a set of genes, a “gene cluster,” that contributes to the polygenic disorder when their sequences are critically modified. As used herein, a gene cluster, C, is defined as a set of genes, the members of which are grouped by their ability to harbor genetic polymorphisms that contribute or predispose to disease, D. D represents a specific phenotype (disease) whose genetic component we wish to identify. There can be two types of gene clusters: “subnetworks” and “subsets.” As used herein, “subnetworks” are sets of genes that are joined through direct molecular interactions into a connected component; “subsets” are groups of genes that can or can not be near one another within a molecular network. By way of example, one gene of a subset can be in the same biochemical pathway as a second gene but not physically or chemically interact therewith.

For every gene within a gene cluster C, a “cluster probability,” pᵢ can be defined. As used herein, pᵢ refers to the i^{th} gene (i=1, . . . , c, where c is the size of the cluster, so the sum of pᵢ over i=1, . . . , c is equal to 1). In other words, pᵢ is the probability that the i^{th} gene is picked at random to be the disease-predisposing loci, given that one of the c genes in the gene cluster C predisposes to disease D. Stated differently, cluster probability pᵢ is the share of guilt attributable to variations in the i^{th} gene for the disease phenotype in a large group of randomly selected disease-affected individuals.

A weak assumption can be made that a gene cluster is a connected component of the molecular network, where nodes represent genes and edges stand for direct (i.e., physical) functional interactions between genes or their products. It is weak because the gene-specific cluster probability parameters allow one to represent discontinuous gene clusters by setting cluster probabilities for some genes to zero. Therefore, a sufficiently large set of genes with appropriate cluster probabilities can represent an arbitrary complex topological arrangement of a set of network-linked genes, albeit at the cost of computational expenses that increases rapidly with an increase in gene-cluster size. Thus, the gene cluster C should include from 2 to 50 genes, and preferably from 5 to 25 genes. In one embodiment, the gene cluster C includes from 10 to 20 genes.

Therefore, disease-contributing genes with larger cluster probabilities are potentially more attractive targets for the development of drugs and diagnostic tests, because a larger number of people affected by the disease will bear disease-predisposing polymorphisms in the corresponding loci. Similarly, a gene that has a zero cluster probability is unimportant with regard to the disease phenotype, even if that gene is a member of the gene cluster with the highest likelihood value.

The disclosed subject matter thus provides extension to the standard multipoint genetic-linkage model combined with detailed molecular, biochemical and structural information from a molecular network. According to the disclosed subject matter, two additional assumptions from the standard multipoint linkage model can be made. First, it can be assumed that a disease-predisposing genetic variation can be harbored by only those genes that are within a gene cluster, C. Second, it can be assumed that, for every family under analysis, exactly one of the genes from cluster C is a D disease-predisposing gene. In other words, the phenotype status of every individual is determined by the state (i.e., the allele) of the family-specific gene in the individual's genome. Thus, given the state of the chosen gene, the disease-phenotype state of the individual is independent of the rest of the individual's genome and of the genotypes and phenotypes of her/his family members. These assumptions lead to the Equation (4):

$$\begin{matrix}P ( YC , Θ ) = {\prod }_{f ∈ families} P ( {Y}_{f} \vert C = \{ {gene}_{1} … , {gene}_{c} ) , Θ ) \\ = {\prod }_{f ∈ families} [ {}_{p 1} P ( {Y}_{f} \vert {gene}_{1} predisposes to D , \\ Θ + … + {}_{{p}_{c}} P ( {Y}_{f} \vert {gene}_{c} predisposes to D , Θ ) ] ,\end{matrix} \qquad ( 4 )$$

where C is the disease-predisposing gene cluster, comprising gene₁, gene₂, . . . , gene_{c}, with the corresponding cluster probabilities p₁, p₂, . . . , p_{c}. Variable Y represents a union of the genotypic and phenotypic data; Y_{f} is the portion of these data associated with the f^{th} family (pedigree). Vector θ represents all the linkage-related parameters, including, but not limited to genetic penetrance, background frequencies of marker alleles, and genetic distances between the markers.

According to some embodiments of the disclosed subject matter, a dominant-like penetrance model for all disorders can be used: the frequency of the disease allele can be set to 0.01 and the penetrance parameter can be set to 0.001 for two wild-type alleles, 0.8 for one wild-type and one disease-allele, and 0.8 for two disease alleles.

In the generative model of data, the i^{th} disease-predisposing gene can be assigned to a family by a random draw from the cluster C with probability pᵢ. Once a gene is assigned to a family, the disease-related phenotype variation in this family is probabilistically dependent on the state of the i^{th} gene, and is independent of the states of all other genes in the cluster C and in the rest of the genome. Therefore, different families affected by the same disease under this model can have different disease-predisposing genes that belong to the same gene cluster C.

According to the disclosed subject matter, it is assumed that every gene in cluster C has only one healthy and one disease-predisposing allele, and that the expected frequencies of these alleles are the same for every gene in the cluster C. However, these assumptions can be relaxed at the expense of an increased computational cost and potential loss of the method's statistical power.

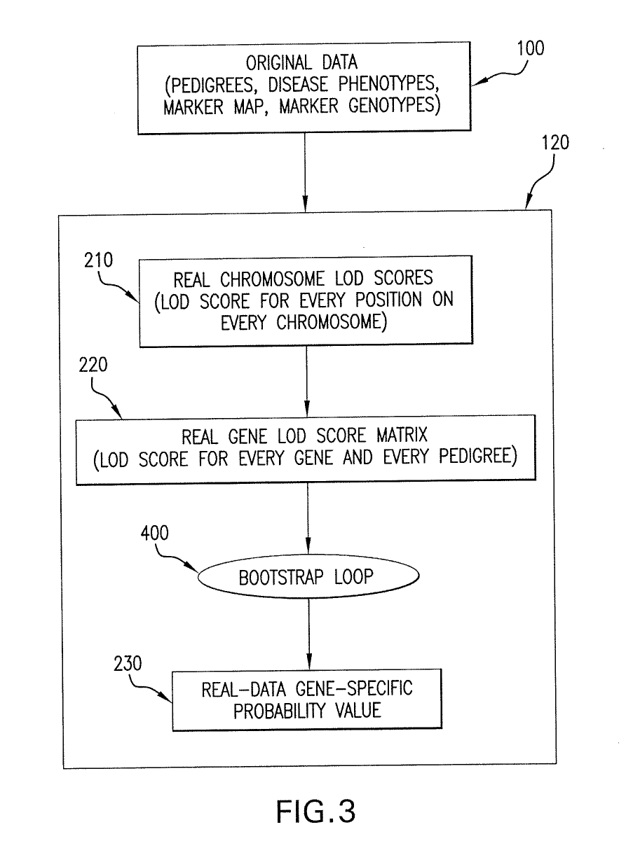

Turning to FIG. 3, an exemplary method for determining the probability value from a data set that one or more genes contribute to the polygenic disorder will be described. From the original data set 100, a log-odds (LOD) score is generated for each chromosome 210. Assuming that there is exactly one D-predisposing genetic locus per family, the LOD score for any individual position (λ) in the genome can be calculated 210 as according to Equation 1:

$$L O {D}_{f} ( λ ) = {log}_{10} \frac{P ( {Y}_{f} \vert D - predisposing position is at λ , Θ )}{P ( \begin{matrix}{Y}_{f} \vert D - \\ predisposing position is unlinked , Θ\end{matrix} )} . \qquad ( 1 )$$

As used herein, “LOD” refers to the measure of the likelihood of the observed data on a logarithmic scale. A LOD score depends on assumed values of the recombination fraction θ. If different θ are tried and the likelihood of each value is calculated, the support for linkage versus the absence of linkage will be largest for one specific θ, which is then considered to be the best estimate of θ. A positive LOD score indicates evidence in favor of linkage; a negative LOD score indicates evidence against linkage. If there is linkage, the maximum LOD score increases with increasing number of families.

From the determination of a LOD score for each chromosome, a LOD score for the genes and families (f) represented in the data set can be calculated 220. Assuming that the beginning and the end of the i^{th} gene is known, a gene-specific LOD score, LOD_{f}(geneᵢ) can be calculated. As used herein, “gene-specific LOD score” refers to the LOD-score in the middle of the gene or at a uniformly sampled position within the gene.

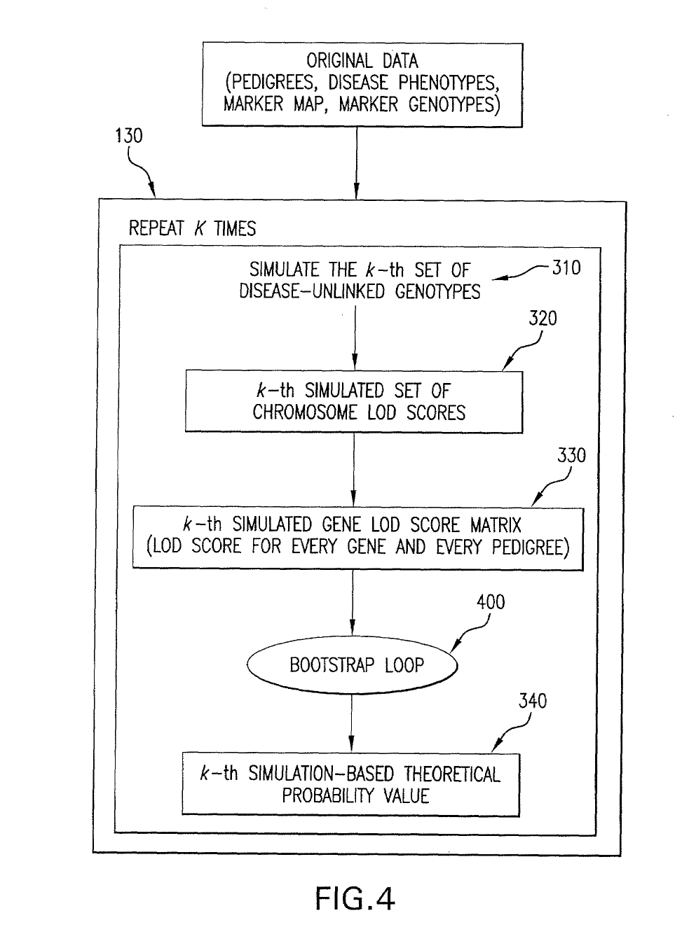

Using a bootstrap loop 400 (described in detail below), a gene-specific statistic value 230 can be calculated. The procedure for determining the gene-specific statistic value can be identical to those used in for the simulated data (discussed with respect to FIG. 4, below) except for the data set.

Turning to FIG. 4, an exemplary method for determining the theoretical probability value 130 that none of the two or more genes none contributes to a polygenic disorder will be described. According to the “distribution under the null model” 130, the procedure involves generating simulated genotypic data under the assumption that the disease phenotype is unlinked to any part of the whole genome, i.e., none of the genes in the genome contribute to the polygenic disorder.

According to one embodiment of the disclosed subject matter, the procedure used to determine the i^{th} gene-specific probability value, p, can be based on the null hypothesis that gene i does not contribute to the polygenic disorder, i.e., does not belong to the disease-contributing gene cluster. In an alternate embodiment, the computation used to compute the i^{th} gene-specific probability value, p, is based on the expected value that the geneᵢ-specific cluster probability pᵢ, is equal to zero. The computational methods discussed herein are by way of example and not of limitation. One of skill in the art would understand that other computational techniques useful to computing a gene-specific probability value can be used in the disclosed subject matter.

Referring to 310 of FIG. 4, data sets can be simulated k^{th} times, where k is chosen to be sufficiently large to provide accurate probability, for example, 1000. In a particular embodiment, for each simulated data set 310, Breiman's “bagging” (bootstrap aggregating) procedure (discussed in detail below) can be used to compute the null distribution of the test statistic for each gene. Alternatively, other computational techniques suitable for computing the null distribution of the test statistic for each gene can be used.

When generating the simulations of the k^{th} set of disease-unlinked genotypes 310, the structure of the pedigrees should be preserved: the phenotype and state of the unobserved markers remains unknown. Simulations can be carried out by first assigning marker alleles to the markers of the founder individuals in the family by sampling from the given marker allele frequency independently for each marker. Then, for every child, the two meioses were simulated for its two parents.

For each meiosis, it can be randomly chosen to have or not a recombination in between all pairs of adjacent markers based upon the transmission probability determined from the distance of the markers on the marker map and the chosen map function. The recombination status for every interval together with the two parental chromosomes uniquely determines the chromosome inherited by the child. The simulation can be carried out using appropriate simulation software, such as commercially available SIMULATE.

Referring to 320 of FIG. 4, a k^{th} simulated set of chromosome LOD scores are next determined using Equation (2), above. A LOD score matrix for the k^{th}-simulated gene can then be identified 330.

At 400 of FIG. 4, bootstrapping over the pedigrees represented in the k^{th} simulated data set. Each bootstrap replicate data set can be obtained by selecting pedigrees from an original data set, at random but with replacement. As a result, each pedigree from the original simulated data set can appear repeated n times, or not at all, in any bootstrap replicate. For each bootstrap replicate, the gene cluster of size C with a maximum cluster LOD score can be identified.

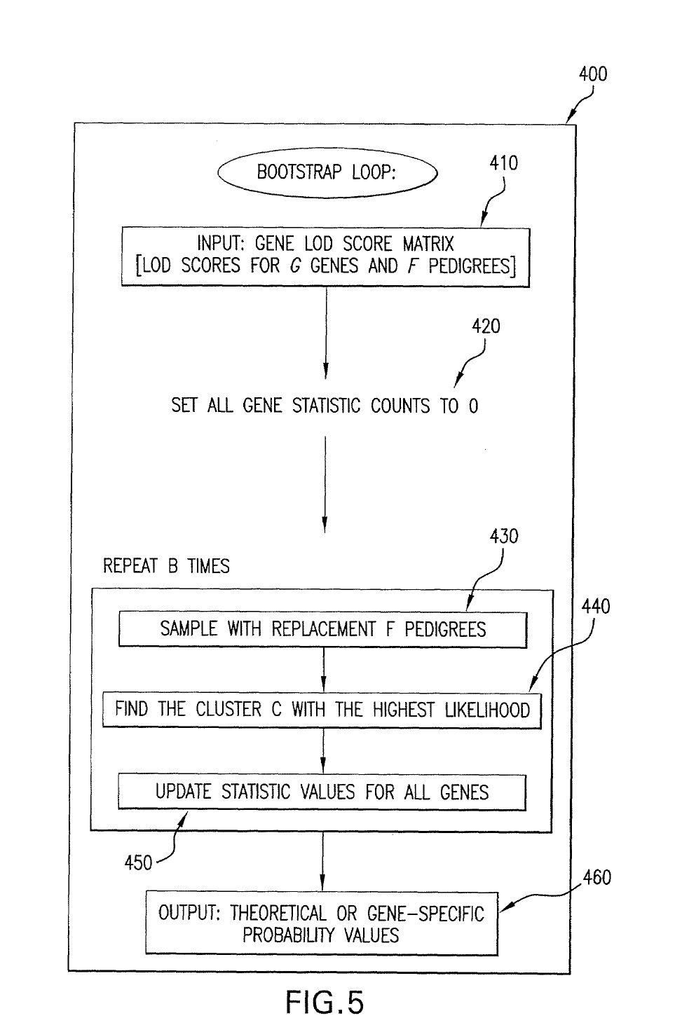

Turning to FIG. 5, the “Bootstrap Loop” 400 will be explained in further detail. The input data 410 for the bootstrap loop 400 can be either the gene LOD score matrix from real data 220 or the gene LOD score matrix from k^{th}-simulated gene data 330. For either input gene LOD score matrix (220 or 330), the gene statistic counts are set to zero 420.

Each bootstrap replicate data set 430 can be obtained by sampling pedigrees from the original data set, at random but with replacement. B bootstrap replicates can be generated, where B ranges from 50-250; preferably, B ranges from 75-200; or from 75-150. As a result, each pedigree from the original data set can appear repeated multiple times in any bootstrap replicate, or not at all.

To avoid the computational cost associated with the large families from the bipolar disorder dataset, the gene LOD score can be simulated and computed for a small number, e.g., 100 simulation instances for the bipolar families. A larger, e.g., 1,000 simulation set can then be created by randomly choosing out of the 100 simulations for every family. Thus, to generate 1000 simulations, for each family one can randomly sample one of the 100 simulations, and can do this sampling 1000 times. For the autism and schizophrenia families as described in the examples herein, because the data sets are significantly smaller, a smaller number of simulations can be made.

Turning to 440, for each bootstrap replicate 430, the gene cluster of size C with the maximum cluster LOD score can be identified 440. The gene cluster size C can ranges from 7 to 25 or 35 genes or more. The optimum cluster size C can be different for different data sets, and can be determined empirically.

As used herein, gene-cluster LOD score is defined by Equation (2):

$$L O D ( C = \{ {gene}_{1} , … , {gene}_{c} \} , Θ ) = {log}_{10} \frac{P ( Y \vert C = \{ {gene}_{1} , … , {gene}_{c} \} , Θ )}{P ( Y \vert C = \{ \} , Θ )} , \qquad ( 2 )$$

where P(Y|C={ }, θ) is the familiar probability P(Y_{f}|D-predisposition position is unlinked, θ), renamed to emphasize its relation to gene clusters. A gene cluster LOD score can be calculated using Equation (3):

$$L O D ( C = \{ {gene}_{1} , … , {gene}_{c} \} , Θ ) = {\sum }_{f} {log}_{10} {\sum }_{i = 1}^{c} {p}_{i} \frac{P ( {Y}_{f} \vert {gene}_{i} predisposes to D )}{P ( {Y}_{f} \vert D - predisposing position is unlinked , Θ )} = {\sum }_{f} {log}_{10} {\sum }_{i = 1}^{c} {p}_{i} {10}^{{LOD}_{f ( {gene}_{1} )}} . \qquad ( 3 )$$

In the case of a single-gene cluster (c=1 and pᵢ=1), Equation 4 translates to the sum of the gene-wise LOD scores for all individual families.

The LOD score of a cluster C can be determined 440 by first identifying the cluster probability parameters that maximize its LOD score. Any algorithm for determining a LOD score may be used. For example, a gene cluster of size C with the maximum LOD score 440 for the theoretical statistical value (FIG. 4) can be made using a simulated annealing approach. In a particular embodiment, identification of the gene cluster of size C with the maximum LOD score 440 for the gene-specific statistic value (FIG. 3), the cluster probability parameter can be estimated by the maximum likelihood method. For either statistic value (theoretical or gene-specific), all genes not included in the optimum cluster C were assigned cluster probability values of zero. The test statistic over B bootstrap replicates is merely a sum of estimates over individual replicates 460.

Referring to 440, with respect to the theoretical statistic value (FIG. 4), simulated annealing is a random walk through the space of clusters of a given size C in which a new cluster is proposed by randomly removing a gene from the current cluster and adding a random new gene, while ensuring that the genes in the new cluster remain connected. A new cluster can be accepted if its LOD score is higher than the LOD score of the current cluster. If the LOD score of the new cluster is smaller, it is accepted with a probability that is dependent on a parameter, temperature T. The temperature of the annealing decreases through the annealing run. In the beginning the temperature is high and clusters with lower (worse) LOD scores are likely to be accepted; towards the end of the annealing run the temperature is small, making acceptance of smaller LOD scores unlikely.

Referring to 450, once the cluster C with the highest LOD score is identified 440, the statistical values for other genes can be updated 450. In one embodiment, the expectation maximization (EM) algorithm can be used as an iterative maximization procedure to update the statistical values.

To decrease the computational cost of the simulated annealing, the annealing iterations can be divided into two parts. In the first part (the “hotter” part, with higher annealing temperatures), the cluster probabilities obtained over only one EM update starting from uniform cluster probabilities were used. In the second part (the “colder” part, with lower temperatures), the cluster probabilities after EM has converged (which can take several hundred iterations to converge) can be used. This is motivated by the observation that a strong positive and statistically significant correlation between the cluster LOD scores with maximum likelihood cluster probabilities and the LOD score with the cluster probabilities after one EM update.

In a particular embodiment, as exemplified in Examples 1-7, 5,000 annealing iterations for the gene-specific significant experiments can be run, as well as 20,000 runs of 10,000 annealing iterations each for identifying the best clusters of the real data. In every case, the last 100 iterations of the annealing run can use the maximum likelihood estimates of the cluster probabilities. The following probability of accepting a cluster with a smaller LOD score is shown in Equation (5):

P_{accept}=e^{LOD}_{new}−^{LOD}_{new}/T (5)

When the initial temperature T=10, and every 10% of the iterations the temperature can be decreased by a factor of 0.4.

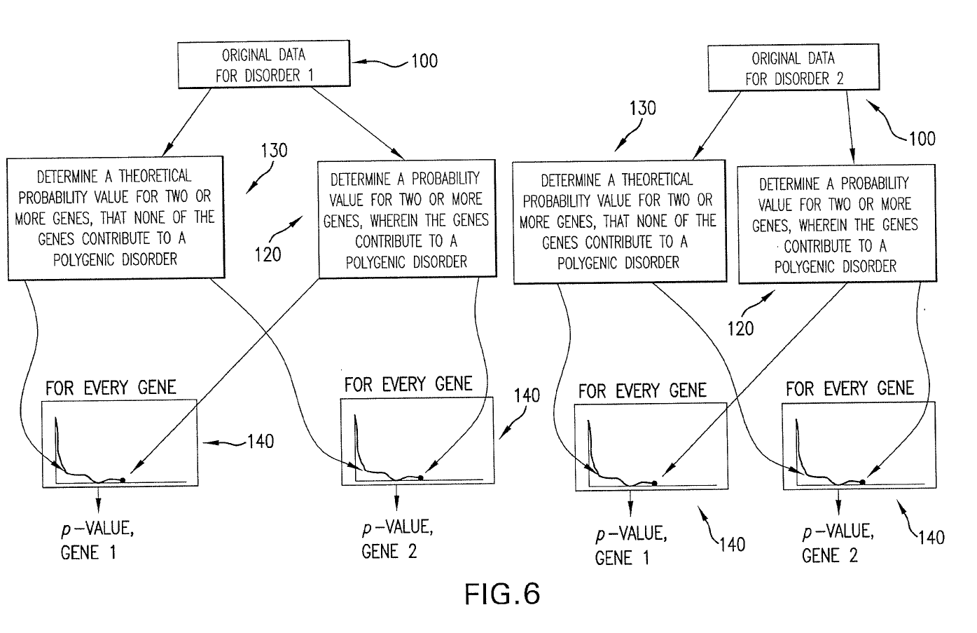

Turning to FIG. 6, a method for identifying one or more genes which contributes to two or more inherited diseases will be described. The method includes identifying, in separate determinations for each of the two or more diseases, one or more genes that contribute to each disorder. The method can be exactly as described in FIG. 1 (high level view) and FIGS. 3-5.

Turning to 610, the overlap of genes that are statistically significantly liked to two or more disorders is determined. The significance of the overlap between lists of candidate genes between two or more diseases can be calculated in at least two ways. One approach (“local overlap”) involves assigning each gene a two, three (or more)-disorder-specific overlap p-value. According to this approach, the “overlap p-value” is calculated by multiplying the disorder-specific p-values for each gene. Thus, an overlap p-value between two traits is the p-value for a given gene contributing to a first trait is multiplied by the p-value for the same gene contributing to a second trait. For three traits, the overlap p-value is the p-value for a given gene contributing to a first trait is multiplied by the p-value for the same gene contributing to a second trait multiplied by the p-value of the same gene contributing to a third trait.

Because the three data sets are statistically independent, the p-value multiplication step is allowed. While computing the local overlap p-values, the zero estimates of the disorder-specific values are substituted with 0.0005 (half of the smallest positive p-value that can be estimated in 1,000 data simulations)—otherwise each gene that has a zero estimate of p-value for at least one disorder, would also have a zero estimate of local overlap p-value regardless of the p-value estimates for the rest of the disorders.

Another approach (“global overlap”) for measuring the significance of the overlap involves estimating overlap significance related to the total number of overlapping genes, regardless of their identity. To compute the global overlap p-value, the simulated phenotype-unlinked data sets per disorder are used. To measure the significance of the two-way global overlap, the distribution of the number of overlapping genes by computing random overlap between pairs of simulated data sets for the two diseases. For every data set, gene-specific p-values can be estimated by using the other disorder-specific simulated datasets to build a background distribution. A gene is included in the overlap between the two disorders if both of its disorder-specific p-values are smaller than a predefined threshold.

In particular embodiments as exemplified in Examples 1-3, the p-values 140 were defined as 0 for autism, bipolar disorder and schizophrenia. The p-value 140 can be defined as any value, however, depending on the various parameters of the instant disclosed subject matter, e.g., the number of nodes in the network; the cluster size C, the number of bootstrap B iterations, etc.

The two different approaches measure the significance of overlap under different null models and thus produce different results. The local overlap p-value for a specific gene measures how likely a gene that is unlinked to any of the disorders will have a signal (gene-specific statistic) as strong as or stronger than the actual values of the gene-specific statistics for each of the disorders considered. The global overlap p-value evaluates the probability of observing a spurious overlap of k genes (unlinked to any of the disorders) between two or three disorders, averaged over all possible overlapping sets of genes of the same cardinality, k.

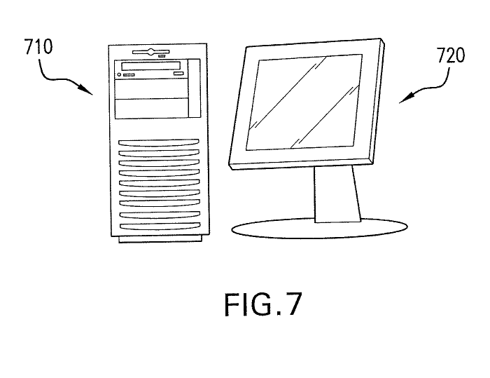

Referring to FIG. 7, exemplary hardware components for implementing the methods described above are shown. A computer or processor unit 710 can be used to run the computations of the present disclosed subject matter and the results can be visualized on a display 720.

The disclosed subject matter also provides for a method of diagnosing one or more heritable disorders in an individual suspected of being afflicted with one or more heritable disorders. In one embodiment, the method includes identifying one or more genes associated with one or more heritable disorders, and comparing the one or more genes with genes of the individual suspected of being afflicted with the one or more heritable disorders, to detect the presence of the one or more genes associated with a disorder in the genes of the individual indicates. For example, the method can be used to diagnose schizophrenia in an individual by comparing the allele of SNAP23 identified as being associated with development of the schizophrenia to the allele carried by the individual. If the individual carries the same allele as that identified as associated with the disease, the individual can be diagnosed with schizophrenia.

Because bipolar disorder, schizophrenia and autism are complex neurodevelopmental disorders with overlapping symptoms, identification of genes overlapping more than one disorder can be used, in combination with further diagnostic criteria, to diagnose the precise disorder(s) afflicting an individual.

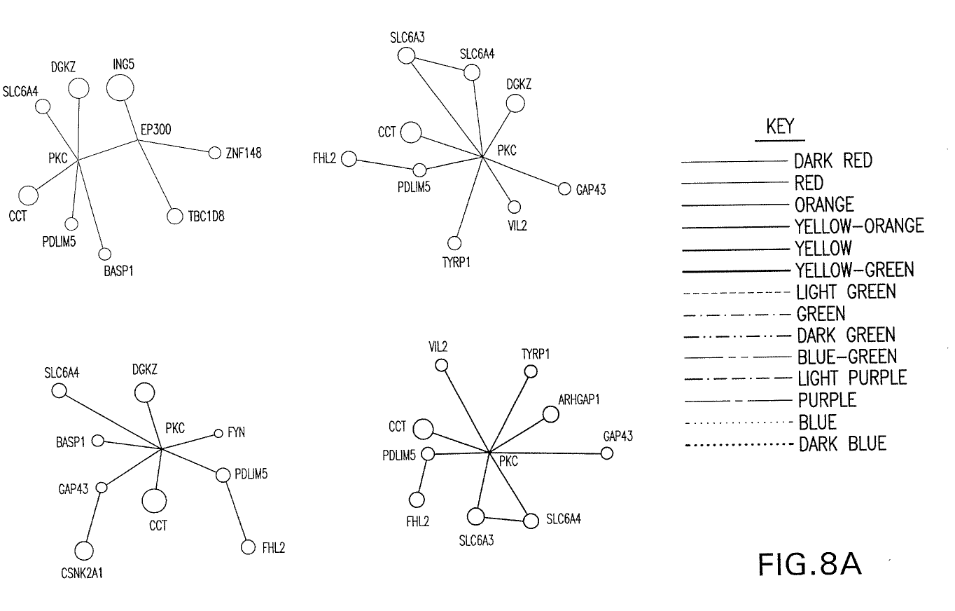

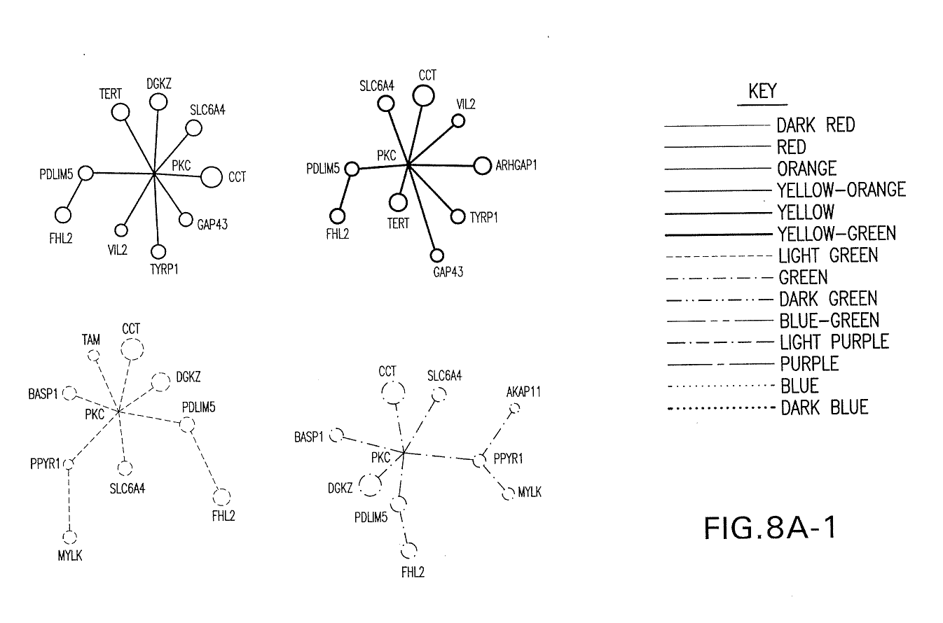

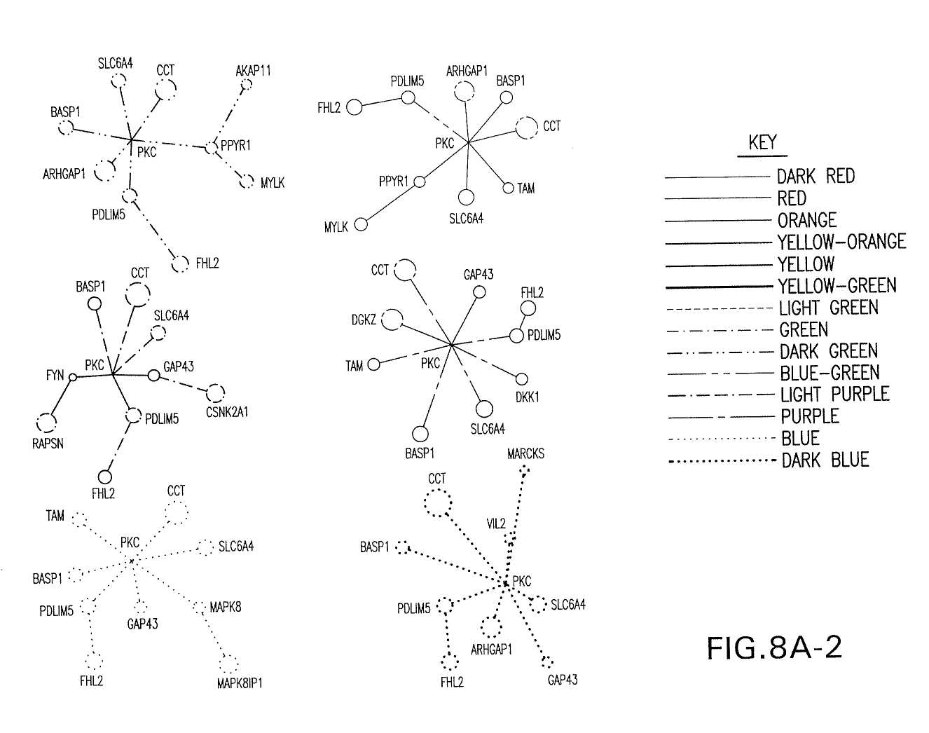

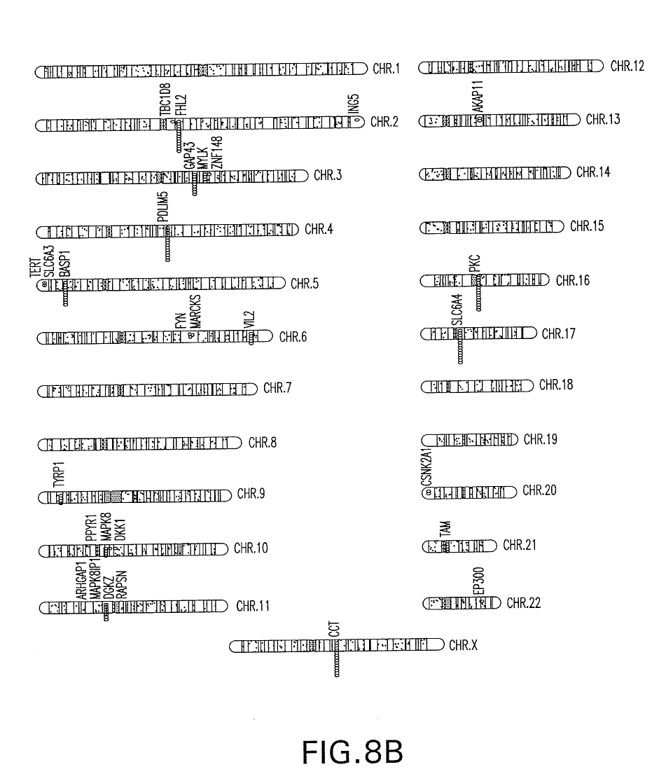

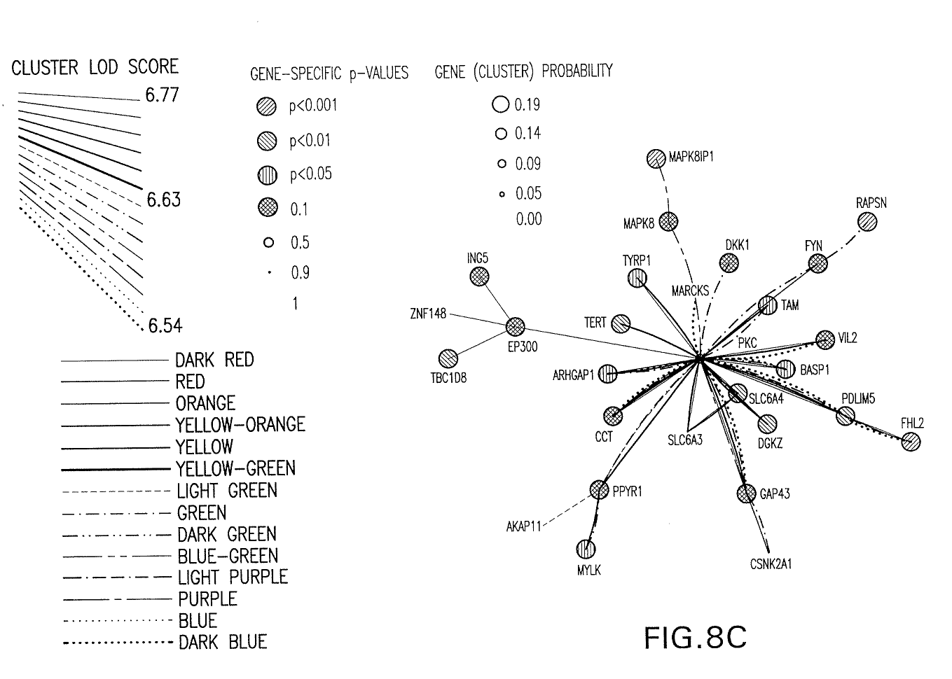

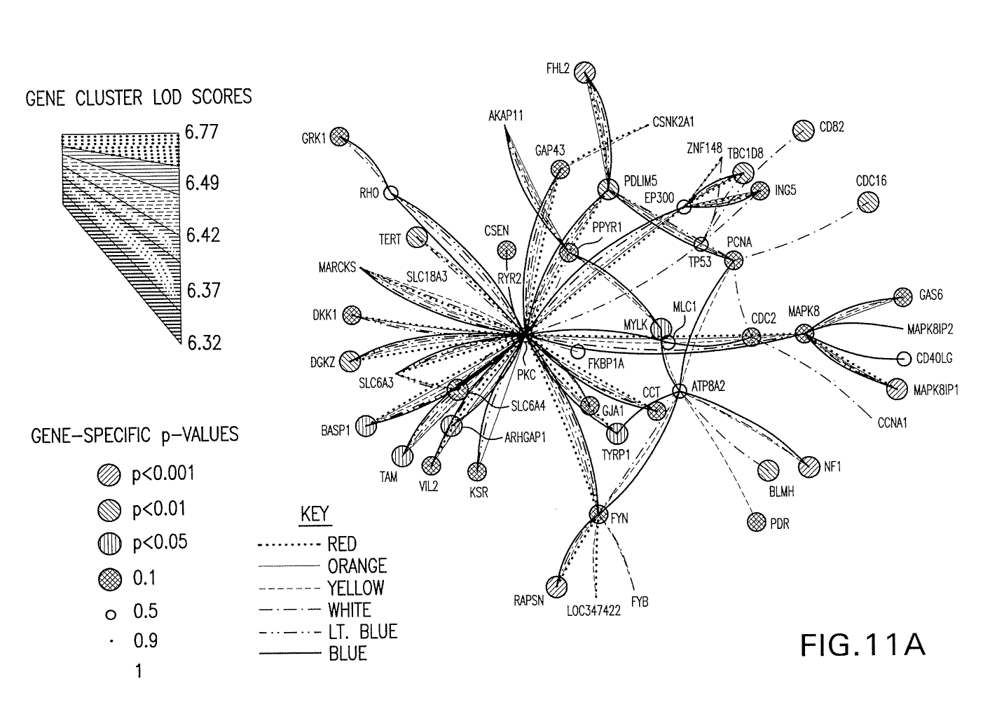

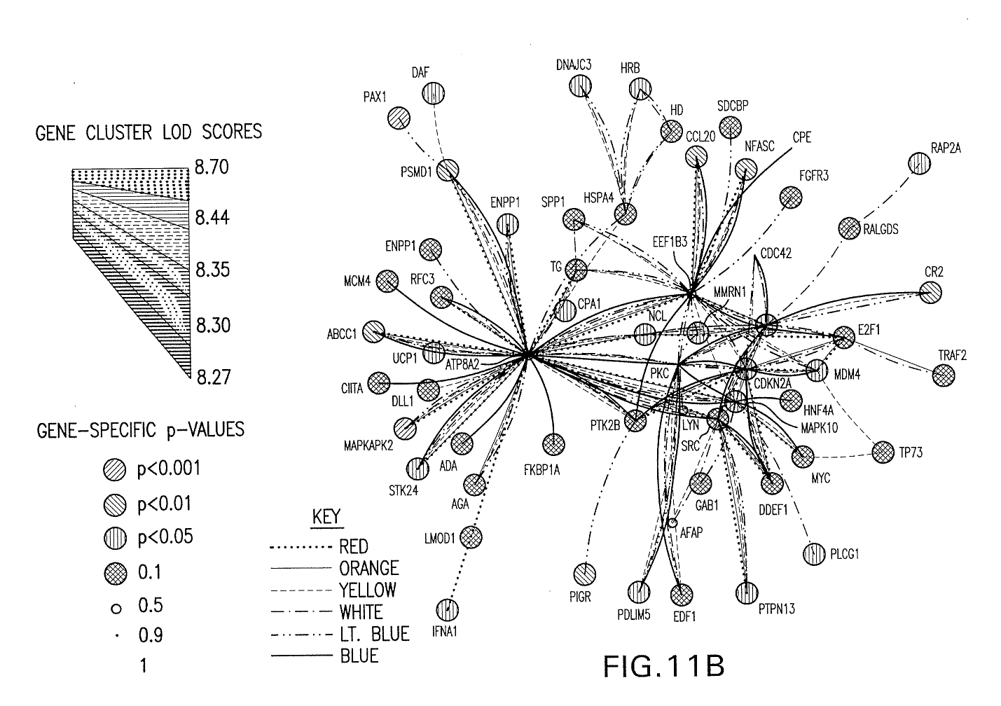

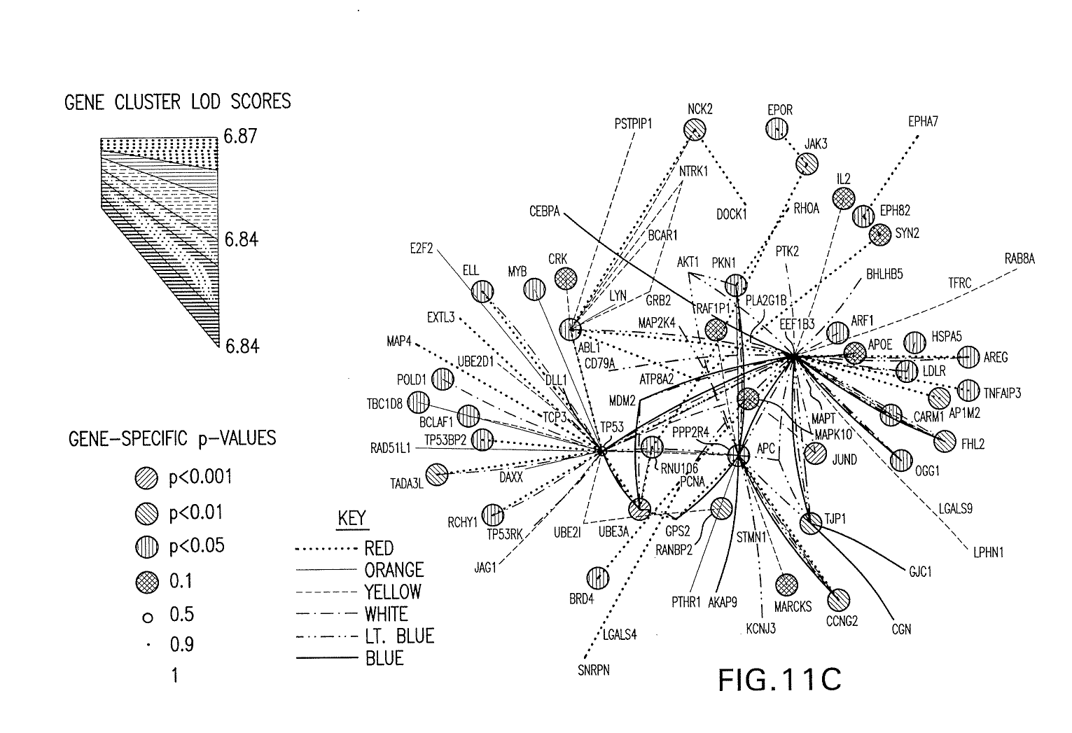

The disclosed subject matter will be more readily understood by referring to the following Examples and FIGS. 8-11.

### EXAMPLES

### Example 1

### Autism-Specific Genes

A search for genes contributing to autism was carried out, using the data set comprising 33 families and 334 markers, with each marker analyzed for each individual. The diagnostic criteria included autism, pervasive developmental disorders, and Asperger syndrome. The population was mixed ethnicity.

FIG. 8 shows the results of the autism linkage analysis across the genome. FIG. 8A shows the analysis of the 14 gene clusters from the molecular network that received the highest LOD scores from the whole genome linkage analysis for autism. Each cluster is shown separately and includes one gene that is likely to contribute to autism in an individual. The vertex size represents the cluster probability estimated for the corresponding gene. A gene represented by a larger node indicates a higher probability that the gene is contributing to autism. FIG. 8B shows a representation of the location on the autosomes of each gene from the 14 gene clusters of FIG. 8A.

FIG. 8C shows the molecular network combining the 14 clusters in one graph. In this representation, the colors and the sizes of nodes indicate gene-specific p-values associated with each gene.

Following Lander and Kruglyak's well-known guidelines (Lander and Kruglyak, Genetic dissection of complex traits: guidelines for interpreting and reporting linkage results, Nature Genet., 11, 241-247, 1995), all candidate genes were for autism, bipolar disorder and schizophrenia represented in the molecular network were classified as highly significant or suggestively significant. Table 1 shows highly significant (with a p-value of 0) and suggestively significant (with a false discovery rate less than 0.5) linkage results for autism, bipolar disorder and schizophrenia, rank-ordered based on their gene-specific p-values. All genes with significance of either their MAX or their SUM statistics are shown. MAX is the maximum of statistic values for the gene observed in B bootstrap replications. SUM is the sum of all statistic values for the gene in B bootstrap replications.

TABLE 1
Highly Significant And Suggestively Significant Genes

| | | | | | |
|---|---|---|---|---|---|
| | | Chromosome | | Max | Sum |
| GeneID | Symbol | Location | Gene Name | p-value | p-value |

Autism

| | | | | | |
|---|---|---|---|---|---|
| 6422 | SFRP1 | 8p12-p11.1 | secreted frizzled-related protein 1 | 0.0000 | 0.0064 |
| 6359 | CCL15 | 17q11.2 | chemokine (C-C motif) ligand 15 | 0.0001 | 0.0002 |
| 2260 | FGFR1 | 8p11.2-p11.1 | fibroblast growth factor receptor 1 | 0.0002 | 0.0299 |
| 4364 | MRSD | Xq27-q28 | mental retardation-skeletal dysplasia | 0.0003 | 0.0003 |
| 642 | BLMH | 17q11.2 | bleomycin hydrolase | 0.0006 | 0.0010 |
| 3960 | LGALS4 | 19q13.2 | galectin 4 | 0.0006 | 0.0242 |
| 2274 | FHL2 | 2q12-q14 | four and a half LIM domains 2 | 0.0015 | 0.0006 |
| 6147 | RPL23A | 17q11 | ribosomal protein L23a | 0.0019 | 0.0004 |
| 9479 | MAPK8IP1 | 11p12-p11.2 | MAPK-8 interacting protein 1 | 0.0025 | 0.0003 |
| 5913 | RAPSN | 11p11.2-p11.1 | synaptic receptor-associated protein | 0.0081 | 0.0007 |

Bipolar Disorder

| | | | | | |
|---|---|---|---|---|---|
| 23114 | NFASC | 1q32.1 | neurofascin homolog (chicken) | 0.000 | 0.006 |
| 5911 | RAP2A | 13q34 | member of RAS oncogene family | 0.000 | 0.011 |
| 983 | CDC2 | 10q21.1 | cell division cycle 2 | 0.000 | 0.030 |
| 5075 | PAX1 | 20p11.2 | paired box gene 1 | 0.004 | 0.000 |
| 9261 | MAPKAPK2 | 1q32 | MAPK-activated protein kinase 2 | 0.020 | 0.000 |

Schizophrenia

| | | | | | |
|---|---|---|---|---|---|
| 8773 | SNAP23 | 15q15.1 | synaptosomal-associated protein | 0.000 | 0.000 |
| 9524 | GPSN2 | 19p13.12 | glycoprotein, synaptic 2 | 0.000 | 0.000 |
| 321 | APBA2 | 15q11-q12 | amyloid β precursor protein-binding | 0.000 | 0.001 |
| 3718 | JAK3 | 19p13.1 | Janus kinase 3 (leukocyte) | 0.000 | 0.004 |
| 8440 | NCK2 | 2q12 | NCK adaptor protein 2 | 0.000 | 0.005 |
| 4948 | OCA2 | 15q11.2-q12 | oculocutaneous albinism II | 0.001 | 0.000 |
| 5731 | PTGER1 | 19p13.1 | prostaglandin E receptor 1 | 0.001 | 0.000 |
| 7337 | UBE3A | 15q11-q13 | ubiquitin protein ligase E3A | 0.001 | 0.000 |
| 439 | ASNA1 | 19q13.3 | arsA arsenite transporter | 0.001 | 0.006 |
| 3727 | JUND | 19p13.2 | jun D proto-oncogene | 0.007 | 0.000 |
| 7082 | TJP1 | 15q13 | tight junction protein 1 | 0.008 | 0.001 |

A closer look at the candidate genes reveals that many are regulators of cell cycle and cell death (for example, EDAR, BCL2L11, NEK6, SFRP1, and MPK7). Another smaller subset of genes is responsible for forming intercellular contacts (tight junction protein 1 (TJP1), LGALS4, MMRN1, IBSP, and NPHP1). A few genes are brain-specific growth and signal-transduction receptors and small-molecule transporters (RAPSN, APBA2, UBE3A, ALK and KCNB1); a few are related to the immune response (for example, CCL15, CSF2, DAF, IL10.

### Example 2

### Bipolar-Specific Genes

A whole genome linkage analysis was carried out on three independent data sets, for each of which the phenotypic criterion was BP1, a major psychiatric disorder characterized by mania alternating with periods of depression (schizoaffective disorder manic type). The first data set includes 10 families processed with the MORGAN program, and 31 GeneHunter families processed with the GeneHunter program, with a total of 332 markers, as analyzed by Park et al., 2004, “Linkage analysis of psychosis in bipolar pedigrees suggests novel putative loci for bipolar disorder and shared susceptibility with schizophrenia,” Mol. Psychiatry, 9:1091-9. The population was Caucasian from the U.S. and Israel. The second data set includes 153 Caucasian families, one of which was processed with the MORGAN program and 152 processed with GeneHunter, with a total of 382 markers analyzed. The third dataset includes the National Institutes of Mental Health Schizophrenia/Distribution 3.0/BP Dataset 4 (Genome Screen). The total number of families was 276, with one family processed with the MORGAN program and the remaining processed with GeneHunter. A total of 384 markers were analyzed for each individual and the state of each marker was determined. The selection criterion was set for a p-value=0. The number of genes represented in the molecular network was approximately 4000.

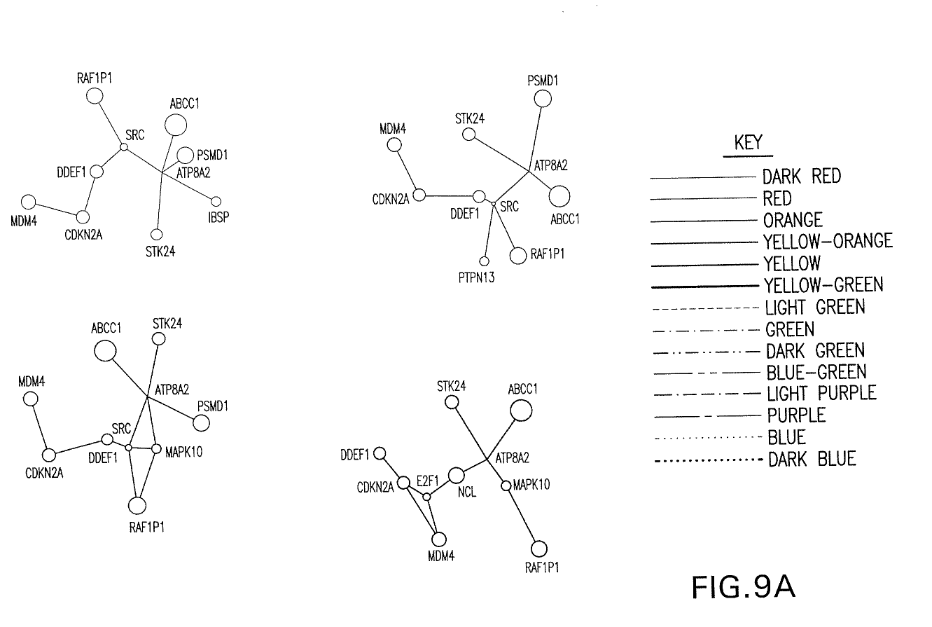

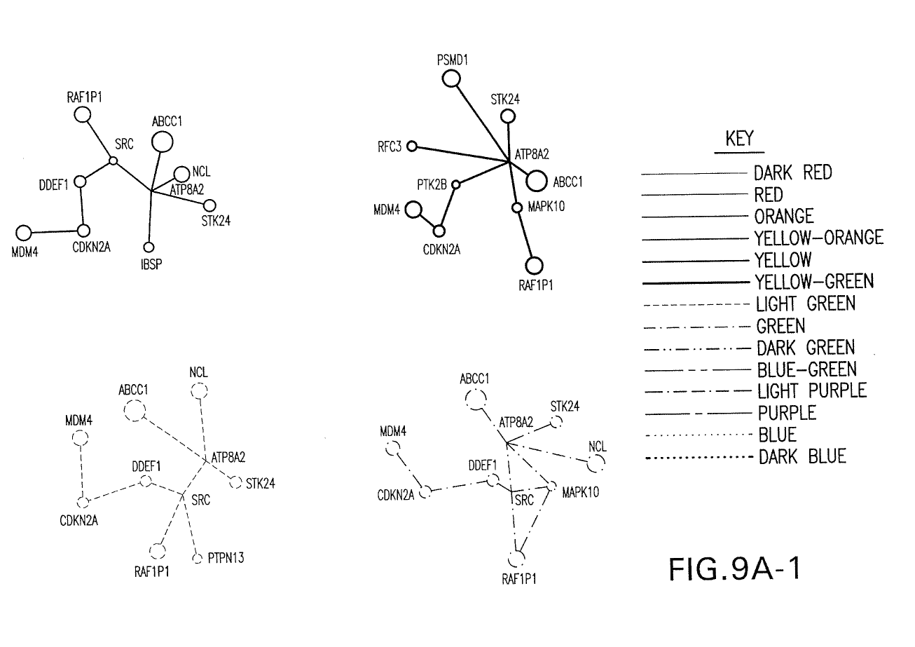

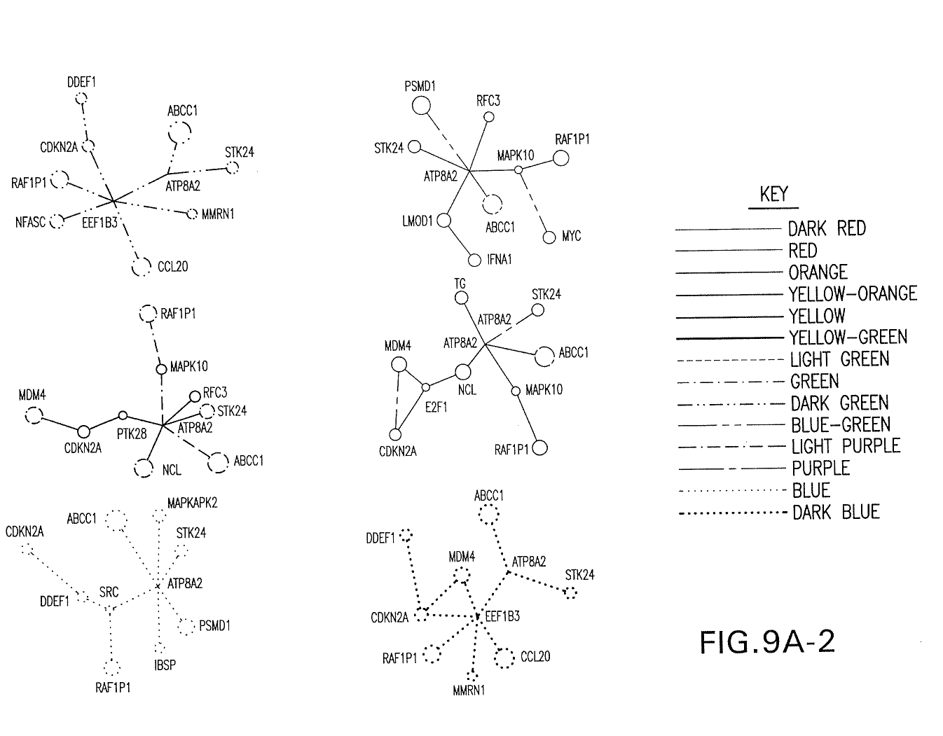

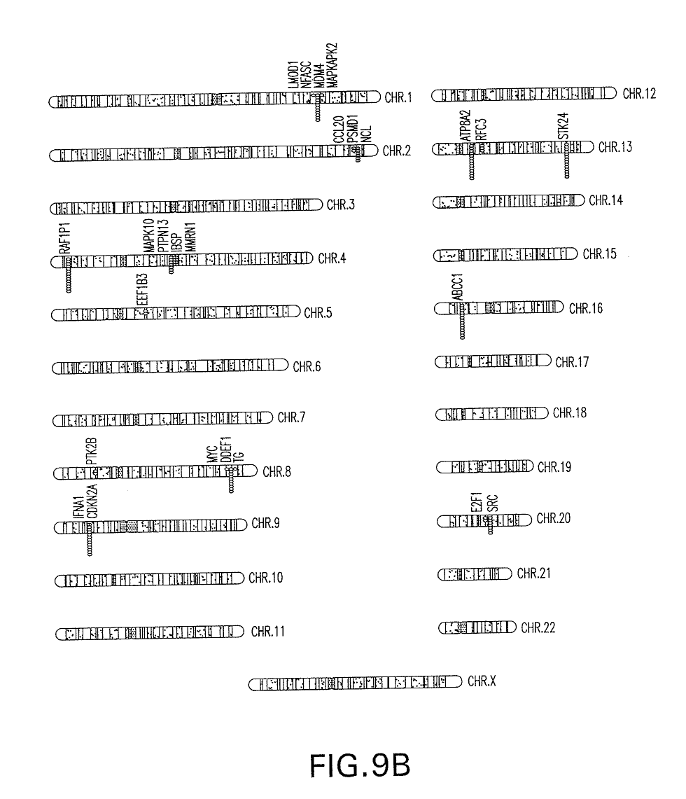

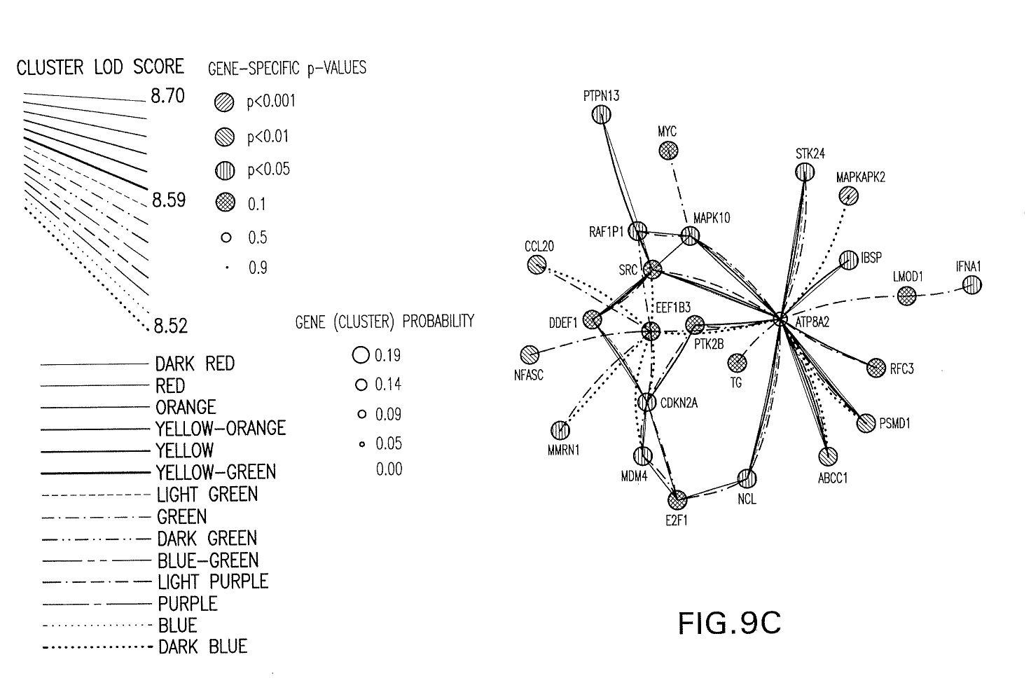

FIG. 9 shows the results of the bipolar disorder linkage analysis across the genome. FIG. 9A shows the analysis of the 14 gene clusters from the molecular network that received the highest LOD scores from the whole genome linkage analysis for bipolar disorder. Each cluster is shown separately and comprises one gene that is likely to contribute to bipolar disorder in an individual. The vertex size represents the cluster probability estimated for the corresponding gene. A gene represented by a larger node indicates a higher probability that the gene is contributing to bipolar disorder. FIG. 9B shows a representation of the location on the autosomes of each gene from the 14 gene clusters of FIG. 9A.

FIG. 9C shows the molecular network combining the 14 clusters in one graph. In this representation, the colors and the sizes of nodes indicate gene-specific p-values associated with each gene.

Table 1 (above) shows highly significant and suggestively significant linkage results for bipolar disorder.

### Example 3

### Schizophrenia-Specific Genes

A whole genome linkage analysis according to the methods of the disclosed subject matter for genes contributing to schizophrenia was carried out on the National Institute of Mental Health Schizophrenia, Distribution 2.0 SZ Dataset 8. The data set included 94 families, and 473 markers, each of which was analyzed for each individual. The diagnostic criteria included schizophrenia, schizoaffective disorder depressed; schizotypal personality disorder or nonaffected psychotic disorder or mood-incongruent disorder; schizoid personality disorder or mood-congruent psychotic depressive disorder or “unknown psychotic disorder” with or without psychiatric hospitalization; and schizoaffective disorder-bipolar type.

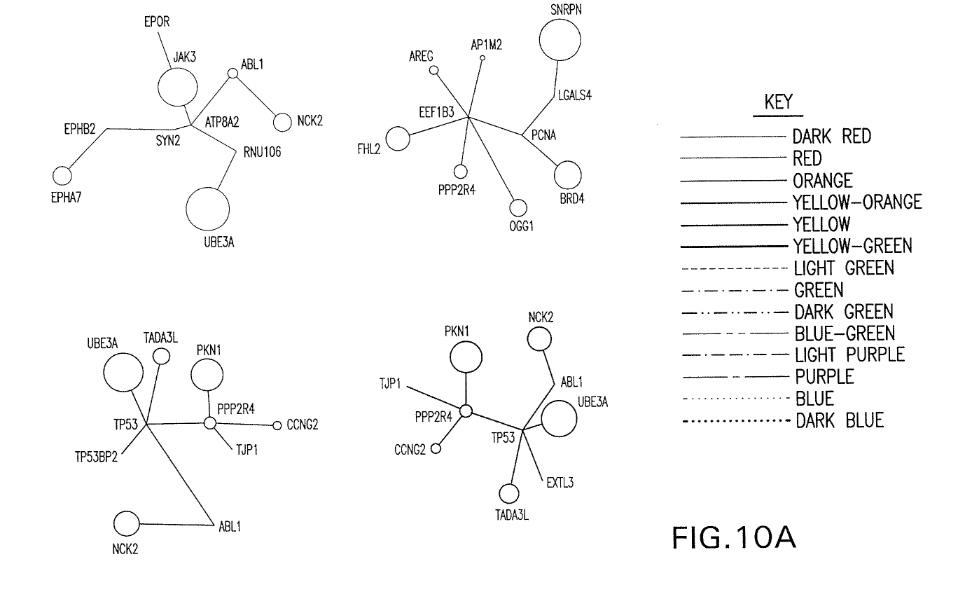

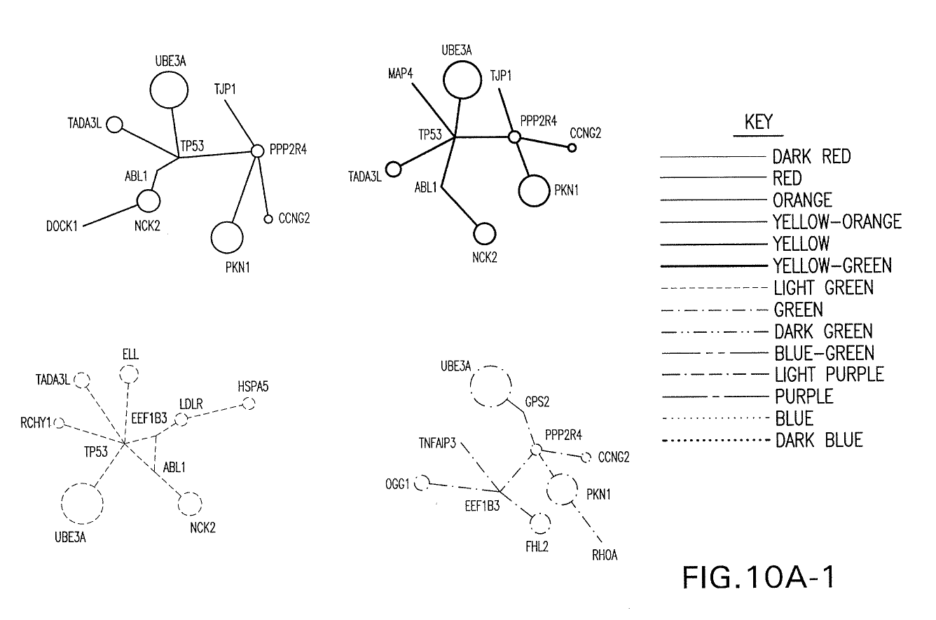

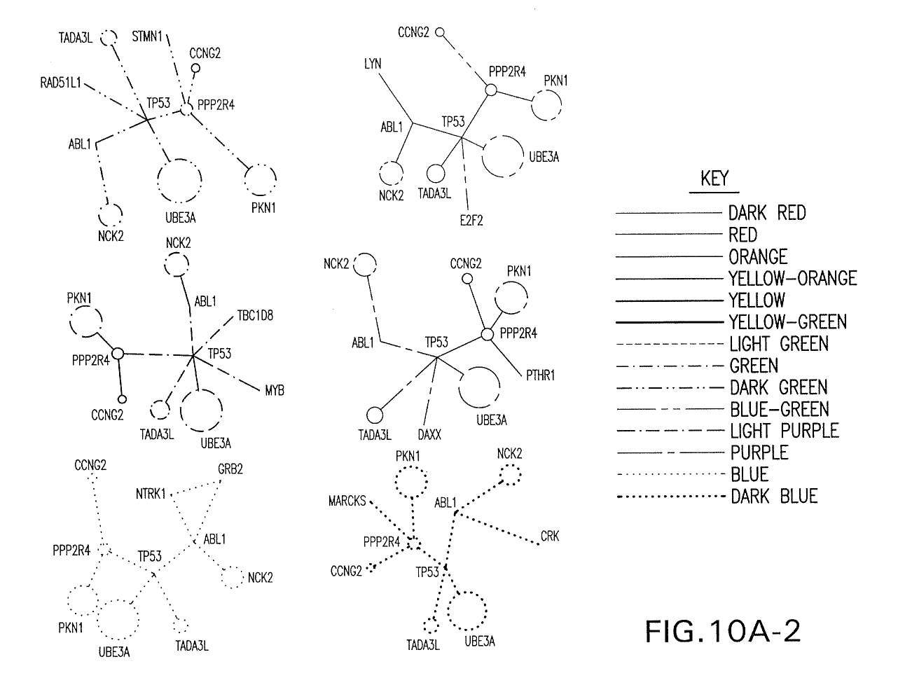

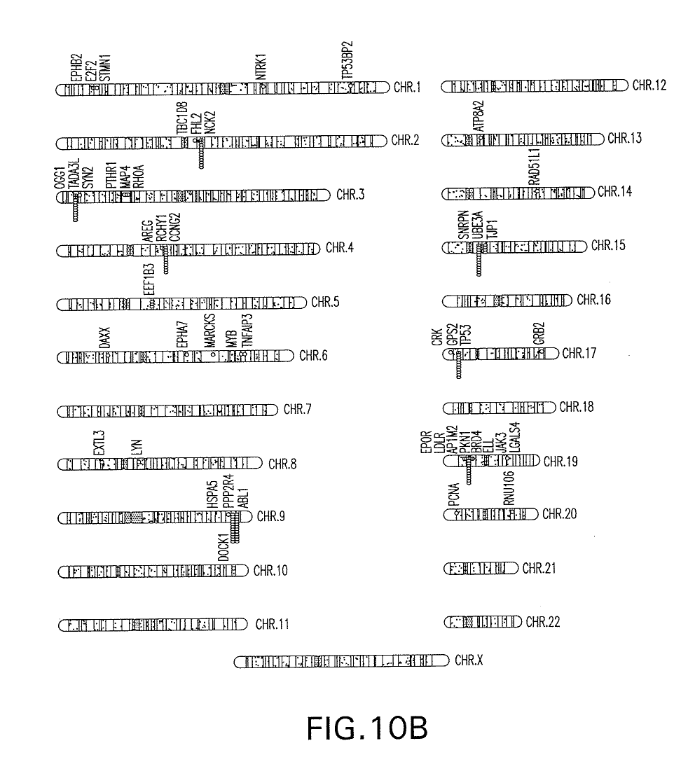

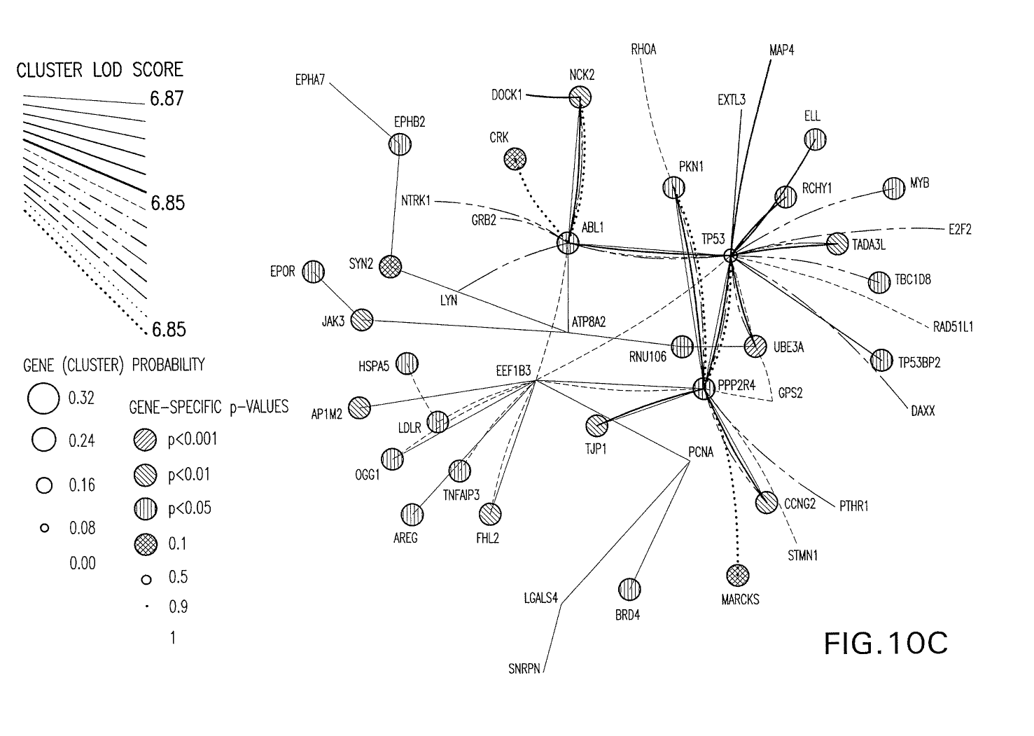

FIG. 10 shows the results of the schizophrenia linkage analysis across the genome. FIG. 10A shows the analysis of the 14 gene clusters from the molecular network that received the highest LOD scores from the whole genome linkage analysis for schizophrenia. Each cluster is shown separately and comprises one gene that is likely to contribute to schizophrenia in an individual. The vertex size represents the cluster probability estimated for the corresponding gene. A gene represented by a larger node indicates a higher probability that the gene is contributing to schizophrenia. FIG. 10B shows a representation of the location on the autosomes of each gene from the 14 gene clusters of FIG. 10A.

FIG. 10C shows the molecular network combining the 14 clusters in one graph. In this representation, the colors and the sizes of nodes indicate gene-specific p-values associated with each gene.

Table 1 (above) shows highly significant and suggestively significant linkage results for schizophrenia.

### Example 4

### Overlap Between Autism and Bipolar Genes

To determine the overlap of genes linked with autism and bipolar disorder, genes showing a statistically significant linkage with autism were identified separately. Independently, genes showing a statistically significant linkage with bipolar disorder were identified from Table 1.

Next, the selection criteria for the statistic value p was redefined, so that the bipolar p-value=0.0005 and the autism p-value=0.0005. One thousand simulated data sets for each disorder were generated to evaluate distribution of genes that are common to bipolar disorder and autism for the redefined p-value cutoff.

Table 2 shows genes that were identified with statistically significant linkage with autism and bipolar disorder.

TABLE 2
Significant Overlaps Between Suggestively Linked Genes For Disorder Pairs And Triplets

| GeneID | Symbol | Location | Gene Name | p-values | | |
|---|---|---|---|---|---|---|
| Autism and Bipolar Disorder | | | | Overlap | Autism | Bipolar |
| 1380 | CR2 | 1q32 | complement component receptor 2 | 0.00019 | 0.094 | 0.002 |
| 5783 | PTPN13 | 4q21.3 | protein tyrosine phosphatase | 0.00057 | 0.019 | 0.030 |
| 7884 | SLBP | 4p16.3 | stem-loop binding protein | 0.00078 | 0.026 | 0.030 |
| 11069 | RAPGEF4 | 2q31-q32 | rap guanine exchange factor 4 | 0.00099 | 0.033 | 0.030 |
| 5602 | MAPK10 | 4q22.1-q23 | MAPK 10 | 0.00127 | 0.067 | 0.019 |
| 8853 | DDEF2 | 2p25 | differentiation enhancing factor 2 | 0.00151 | 0.063 | 0.024 |
| 8881 | CDC16 | 13q34 | cell division cycle 16 | 0.00168 | 0.028 | 0.060 |
| 3745 | KCNB1 | 20q13.2 | potassium voltage-gated channel 1 | 0.00312 | 0.071 | 0.044 |
| 26765 | RNU106 | 20q13.13 | RNA, small nucleolar | 0.00312 | 0.044 | 0.071 |
| 22915 | MMRN1 | 4q22 | multimerin 1 | 0.00419 | 0.091 | 0.046 |
| 5799 | PTPRN2 | 7q36 | protein tyrosine phosphatase | 0.00462 | 0.065 | 0.071 |
| 1869 | E2F1 | 20q11.2 | E2F transcription factor 1 | 0.00465 | 0.093 | 0.050 |
| 4023 | LPL | 8p22 | lipoprotein lipase | 0.00514 | 0.079 | 0.065 |
| 55294 | FBXW7 | 4q31.3 | archipelago homolog (Drosophila) | 0.00555 | 0.059 | 0.094 |
| 4741 | NEF3 | 8p21 | neurofilament 3 | 0.00602 | 0.070 | 0.086 |
| 2444 | FRK | 6q21-q22.3 | fyn-related kinase | 0.00743 | 0.079 | 0.094 |
| 6194 | RPS6 | 9p21 | ribosomal protein S6 | 0.00774 | 0.098 | 0.079 |
| Autism and Schizophrenia | | | | Overlap | Autism | Schiz. |
| 10913 | EDAR | 2q11-q13 | ectodysplasin A receptor | 0.00002 | 0.000 | 0.042 |
| 2274 | FHL2 | 2q12-q14 | four and a half LIM domains 2 | 0.00008 | 0.014 | 0.006 |
| 5903 | RANBP2 | 2q12.3 | RAN binding protein 2 | 0.00015 | 0.022 | 0.007 |
| 9672 | SDC3 | 1pter-p22.3 | syndecan 3 (N-syndecan) | 0.00033 | 0.005 | 0.066 |
| 266710 | COMA | 2q13 | congential oculomotor apraxia | 0.00062 | 0.013 | 0.048 |
| 7188 | TRAF5 | 1q32 | TNF receptor-associated factor 5 | 0.00096 | 0.031 | 0.031 |
| 26765 | RNU106 | 20q13.13 | RNA, small nucleolar | 0.00207 | 0.044 | 0.047 |
| 10018 | BCL2L11 | 2q13 | apoptosis facilitator | 0.00229 | 0.052 | 0.044 |
| 8027 | STAM | 10p14-p13 | signal transducing adaptor 1 | 0.00279 | 0.068 | 0.041 |
| 9994 | CASP8AP2 | 6q15 | CASP8 associated protein 2 | 0.00358 | 0.065 | 0.055 |
| 5602 | MAPK10 | 4q22.1-q23 | MAPK 10 | 0.00516 | 0.067 | 0.077 |
| 9892 | SNAP91 | 6q14.2 | synaptosomal-associated protein | 0.00610 | 0.067 | 0.091 |
| 22915 | MMRN1 | 4q22 | multimerin 1 | 0.00746 | 0.091 | 0.082 |
| 11162 | NUDT6 | 4q26 | nudix-type motif 6 | 0.00768 | 0.080 | 0.096 |
| 5464 | PPA1 | 10q11.1-q24 | pyrophosphatase 1 | 0.00893 | 0.095 | 0.094 |
| Bipolar Disorder and Schizophrenia | | | | Overlap | Bipolar | Schiz. |
| 5707 | PSMD1 | 2q37.1 | proteasome 26S subunit 1 | 0.00027 | 0.005 | 0.053 |
| 685 | BTC | 4q13-q21 | betacellulin | 0.00038 | 0.048 | 0.008 |
| 10611 | PDLIM5 | 4q22 | PDZ and LIM domain 5 | 0.00061 | 0.034 | 0.018 |
| 2159 | F10 | 13q34 | coagulation factor X | 0.00139 | 0.082 | 0.017 |
| 5602 | MAPK10 | 4q22.1-q23 | MAPK 10 | 0.00146 | 0.019 | 0.077 |
| 4691 | NCL | 2q12-qter | nucleolin | 0.00156 | 0.024 | 0.065 |
| 3267 | HRB | 2q36.3 | HIV-1 Rev binding protein | 0.00246 | 0.030 | 0.082 |
| 8720 | MBTPS1 | 16 | transcription factor peptidase | 0.00288 | 0.048 | 0.060 |
| 26765 | RNU106 | 20q13.13 | RNA, small nucleolar | 0.00334 | 0.071 | 0.047 |
| 22915 | MMRN1 | 4q22 | multimerin 1 | 0.00377 | 0.046 | 0.082 |
| 4851 | NOTCH1 | 9q34.3 | notch homolog 1 (Drosophila) | 0.00608 | 0.075 | 0.081 |
| 89874 | SLC25A21 | 14q11.2 | solute carrier family | 0.00822 | 0.083 | 0.099 |
| 2798 | GNRHR | 4q21.2 | gonadotropin-releasing receptor | 0.00861 | 0.087 | 0.099 |

### Example 5

### Overlap Between Autism and Schizophrenia Genes

To determine the overlap of genes linked with autism and schizophrenia, genes showing a statistically significant linkage with autism and schizophrenia were identified independently, as shown in Table 1.

Next, the selection criteria for the statistic value p was redefined, so that the bipolar p-value=0.0005 and the autism p-value=0.0005. One thousand simulated data sets for each disorder were generated to evaluate distribution of genes that are common to bipolar disorder and autism for the redefined p-value cutoff.

Table 2 (above) shows those genes that were identified with statistically significant linkage with overlap autism and schizophrenia.

### Example 6

### Overlap Between Bipolar Disorder and Schizophrenia Genes

To determine the overlap of genes linked with both bipolar disorder and schizophrenia, genes showing a statistically significant linkage with bipolar disorder, and genes showing a statistically significant linkage with schizophrenia, were identified independently, as shown in Table 1.

Next, the selection criteria for the statistic value p was redefined, so that the bipolar p-value=0.0005 and the autism p-value=0.0005. One thousand simulated data sets for each disorder were generated to evaluate distribution of genes that are common to bipolar disorder and autism for the redefined p-value cutoff.

Table 2 shows genes that were identified with p-values suggesting linkage with both bipolar disorder and schizophrenia, some of which are discussed herein.

### Example 7

### Overlap Between Autism, Bipolar Disorder and Schizophrenia Genes

The overlap between autism, bipolar and schizophrenia was analyzed for several reasons. The three disorders, despite their differences, share important symptoms. Autism, which was recognized as an independent disorder relatively recently, was originally called “childhood schizophrenia,” because autism and schizophrenia share multiple symptoms. Similarly, bipolar disorder and schizophrenia form a continuum of phenotypes, with a schizoaffective disorder in the middle (a union of symptoms of both disorders). Furthermore, organic causes of the three disorders remain unknown, so in each case a diagnosis is largely dependent on behavioral symptoms. It has been postulated that the genetic variations underlying similar behavioral symptoms in different disorders might share similarities as well.

To determine the overlap of genes linked with autism, bipolar disorder and schizophrenia, genes showing a statistically significant linkage with autism were identified. (Table 1). Separately and independently, genes showing a statistically significant linkage with and bipolar disorder and schizophrenia (Table 1).

Next, the selection criteria for the statistic value p was redefined, so that, for each of the three disorder, thep-value=0.0005.

Table 2 shows those genes that were identified with statistically significant linkage with autism, bipolar disorder and schizophrenia.

Several top-ranking candidate genes have been considered previously in genetic analyses of complex neurodevelopmental disorders. Bipolar candidate PLCG1 has previously been implicated in bipolar disorder. The ion-transporter MLC1, a highly ranked candidate gene for autism, has been associated with schizophrenia and bipolar disorder. The UBE3A gene has been implicated in autism when inherited as a maternal interstitial duplication, suggesting both genetic and epigenetic causation; our finding of strong gene-cluster contribution for UBE3A in schizophrenia is intriguing in view of multiple reports that genomic imprinting may play a role in disease etiology. Gene expression and association analyses of PDLIM5 (identified in the overlap of bipolar and schizophrenia genes) suggest that it is involved in the etiology of bipolar disorder and schizophrenia, and RAPGEF4 (identified in the overlap of bipolar and autism genes) has been related to the autistic phenotype. Many candidates have been analyzed in relation to Alzheimer's disease: BLMH, MAPK81P1, AMPK4PK2, LPL, NEF3, FRK, and CSEN. Candidate genes that failed to meet our statistical significance criteria include NRG1 and NF1. NRG1 (with gene-specific p-value of 0.001 in one autism analysis), has been long considered by experts as a top schizophrenia candidate gene, and NF1 (p-value of 0.0009 in autism), is known to be genetically linked to neurofibromatosis, a Mendelian genetic disorder with pronounced cognitive symptoms.

All 14 top-ranking autism clusters include the serotonin transporter gene SLC6A4 (p-value of 0.0016 in the autism analysis). The SLC6A4 gene has long been implicated in the genetic etiology of autism based on both genetic and physiological evidence. Moreover, the previous conventional genetic linkage studies of this dataset identified SLC6A4 as the single top-ranking candidate gene. The network analysis suggests that the serotonin transporter's role in autism susceptibility may be mediated via interactions that involve the ‘hub’ molecule, protein kinase C (PKC). The comparison of autism gene networks with schizophrenia and bipolar disorder indicates that, in the latter two disorders, hub or connector genes appear to connect two or more dense gene networks, whereas in autism, the major network candidates appear as direct radius of the PKC hub gene

While the present disclosure is susceptible to various modifications and alternative forms, specific example embodiments have been shown in the figures and are herein described in more detail. It should be understood, however, that the description of specific example embodiments is not intended to limit the disclosed subject matter to the particular forms disclosed, but on the contrary, this disclosure is to cover all modifications and equivalents as defined by the appended claims.

We claim:

1. A method of identifying two or more genes associated with a disease, where each of said genes is a member of a predetermined molecular network, comprising:
a. for each of the two or more genes, determining a gene-specific probability value that two or more genes from said is associated with the disease;
b. for each of the two or more genes, determining a theoretical probability value that the gene does not contribute to the disease; and
c. comparing the probability value from (a) with the probability value of (b), to determine whether the two or more genes are associated with the disease.

2. The method of claim 1, wherein the polygenic disorder is selected from the group consisting of bipolar disorder, schizophrenia and autism.

3. The method of claim 1, wherein identifying the probability value of (a) further comprises determining a LOD score for every position on every chromosome.

4. The method of claim 3, further comprising determining a LOD score for each of the two or more genes and every pedigree.

5. The method of claim 4, further comprising applying a bootstrap loop computation to the LOD scores of claim 4.

6. The method of claim 5, wherein the bootstrap loop comprises generating bootstrap replicate data sets of pedigrees represented in the predetermined data set.

7. The method of claim 6, wherein the bootstrap replicate data sets are obtained by selecting pedigrees from the predetermined data set at random but with replacement.

8. The method of claim 6, further comprising determining a gene cluster with a maximum cluster LOD score.

9. The method of claim 6, wherein the gene cluster LOD score is calculated as follows:
$$L O D ( C = \{ {gene}_{1} , … , {gene}_{c} \} , Θ ) = {\sum }_{f} {log}_{10} {\sum }_{i = 1}^{c} {p}_{i} \frac{P ( {Y}_{f} \vert {gene}_{i} predisposes to D )}{P ( {Y}_{f} \vert D - predisposing position is unlinked , Θ )} = {\sum }_{f} {log}_{10} {\sum }_{i = 1}^{c} {p}_{i} {10}^{{LOD}_{f ( {gene}_{1} )}} . \qquad ( 3 )$$

10. The method of claim 8, further comprising updating statistical values for the two or more genes to generate a gene-specific probability value.

11. The method of claim 1, wherein identifying the probability value of (b) further comprises simulating k data sets from the predetermined data set.

12. The method of claim 11, further comprising determining a k^{th}-simulated set of chromosomal LOD scores.

13. The method of claim 12, further comprising determining a LOD score of the each of the two or more genes and every pedigree of the k^{th}-simulated datasets

14. The method of claim 12, further comprising updating statistical values for the two or more genes to generate a theoretical probability value.

15. A method for identifying two or more genes associated with a disease comprising:
a. defining a network comprising two or more related genes;
b. selecting a test gene from the network; and
c. in a data set containing marker loci for an afflicted pedigree, determining the probability that one or more markers in or near the chromosomal locus containing the test gene varies between members afflicted with the disease and members not afflicted with the disease.

16. The method according to claim 15, further comprising, if there is at least one other gene in the network that has not been a test gene, repeating (b)-(c) for said other gene;

17. The method according to claim 16, further comprising, once the desired number of genes in the network have been tested relative to a given afflicted pedigree, repeating steps (b)-(c) for a second afflicted pedigree.

18. The method according to claim 17, further comprising determining the aggregate probability that two or more genes in a cluster within the network is associated with the disease.

19. A method of identifying two or more genes associated with two or more diseases, wherein each of said genes is a member of a predetermined molecular network, comprising:
a. for each disease, identifying a gene-specific probability value that two or more genes are associated with the disease;
b. for each of the two or more genes, determining a theoretical probability value that none of the two or more genes is involved in any of the diseases;
c. comparing the probability value from (a) for a first gene with the probability value of (b), to determine whether the two or more genes are associated with the diseases; and
d. determining an overlap probability value from the probability value from (c) for each of two or more genes contributing to each of the two or more polygenic disorders and to a second polygenic disorder, wherein a high (overlap) probability value correlates with an association of the two or more genes with the two or more diseases.

20. The method of claim 19, wherein the two or more genes that contribute to each disease are identified according to the method of claim 1.

21. The method of claim 19, further comprising determining an overlap probability value that the two or more genes contribute to the two or more diseases.

22. The method of claim 21, wherein the overlap probability value is the product of a probability value for a given gene associated with a first of the two or more diseases and a probability value for the given gene associated with a second of the two or more diseases.

23. The method of claim 22, wherein the two or more diseases that the two or more genes are associated with are selected from the group consisting of bipolar disorder and schizophrenia; bipolar disorder and autism; schizophrenia and autism, and bipolar, schizophrenia and autism.

24. A method of treating a heritable genetic disease in a patient in need of treatment for the heritable disorder, comprising:
a. identifying two or more genes that associate with the heritable disease according to claim 1; and
b. administering to the patient an agent that modulates the two or more genes that associate with the heritable disease, wherein the heritable disease is bipolar disorder, schizophrenia or bipolar disorder.

25. A method of predicting whether an individual is likely to develop a heritable disease, comprising:
a. identifying two or more genes that contribute to a heritable disease according to the method of claim 1;
b. determining the state of the two or more genes in the individual; and
c. comparing the two or more genes identified in (a) with the state of the two or more genes of the individual of (b),
wherein if the two or more genes identified in (a) are the same as the states of the genes identified in (b), the individual is likely to develop the heritable disease, and wherein the heritable disease is selected from the group consisting of bipolar disorder, schizophrenia and autism.
